(19) United States
(12) Patent Application Publication
(10) Pub. No.: US 2025/0363101 A1
(43) Pub. Date: Nov. 27, 2025

(54) MULTI-VECTOR RETRIEVAL VIA FIXED DIMENSIONAL ENCODINGS

(71) Applicant: Google LLC, Mountain View, CA (US)

(72) Inventors: Rajesh Kumar Jayaram, Brooklyn, NY (US); Vahab Seyed Mirrokni, Short Hills, NJ (US); Jason Daniel Lee, Easton, PA (US); Majid Hadian Jazi, San Jose, CA (US); Laxman Jagannath Dhulipala, Bethesda, MD (US)

(21) Appl. No.: 19/216,687

(22) Filed: May 22, 2025

Related U.S. Application Data
(60) Provisional application No. 63/650,863, filed on May 22, 2024.

(51) Int. Cl. G06F 16/242; G06F 16/2455

(52) U.S. Cl. CPC G06F 16/2438; G06F 16/24554

(57) ABSTRACT

Methods, systems, and apparatus, including computer programs encoded on a computer storage medium, for multi-vector retrieval via fixed dimensional encodings. In one aspect, a method includes: obtaining a set of embedding vectors of a query in an embedding vector space; obtaining an encoded dataset including, for each data item in a set of data items, a respective encoded vector of the data item in a target vector space; encoding the set of embedding vectors of the query in the embedding vector space into an encoded vector of the query in the target vector space; performing, with respect to the encoded vector of the query, a k-nearest neighbors search on the respective encoded vectors of the data items in the encoded dataset; and identifying, from the k-nearest neighbors search, a top-k subset of the set of data items.

### CROSS-REFERENCE TO RELATED APPLICATION

This application claims priority to U.S. Provisional Patent Application No. 63/650,863, titled “MULTI-VECTOR RETRIEVAL VIA FIXED DIMENSIONAL ENCODINGS”, filed on May 22, 2024, which is hereby incorporated by reference in its entirety.

### TECHNICAL FIELD

This disclosure relates generally to methods, systems, and apparatus, including computer programs encoded on a computer storage medium, for performing multi-vector retrieval via fixed dimensional encodings.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a multi-vector retrieval system implemented as computer programs on one or more computers in one or more locations that can reduce a multi-vector similarity search to a single-vector similarity search when performing an information retrieval task, e.g., to retrieve a data item from a dataset in response to a query.

The multi-vector retrieval system implements a principled and practical multi-vector retrieval algorithm for reducing the multi-vector search to the single-vector search by constructing fixed dimensional encoding (or “FDEs”) of a multi-vector representation, e.g., where the FDE inner product space provides high-quality approximations to Chamfer similarity. In experiments, it was shown that FDEs can be a more effective proxy for multi-vector similarity than some current techniques, e.g., involving retrieval of two to four times fewer candidates to achieve the same recall as a baseline heuristic. These results were complimented with an end-to-end evaluation of the multi-vector retrieval system, showing that it achieved an average of 10% improved recall with 90% lower latency compared with PLAID. Moreover, despite the extensive optimizations made by PLAID to the baseline heuristic, the multi-vector retrieval system still achieved significantly better latency on five out of six of the Benchmarking Information Retrieval (“BEIR”) datasets considered in the experiments.

These and other aspects of the methods, systems, and apparatus, including computer programs encoded on a computer storage medium, described herein for performing multi-vector retrieval via fixed dimensional encodings are summarized below.

According to a first aspect, a method performed by one or more computers is provided. The method includes: obtaining a set of embedding vectors of a query in an embedding vector space; obtaining, for each of a plurality of data items, a respective encoded vector of the data item in a target vector space; encoding the set of embedding vectors of the query in the embedding vector space into an encoded vector of the query in the target vector space; performing, with respect to the encoded vector of the query, a k-nearest neighbors search on the respective encoded vectors of each of the plurality of data items; and identifying, from the k-nearest neighbors search, a top-k subset of the plurality of data items.

In some implementations of the method, obtaining the set of embedding vectors of the query in the embedding vector space includes: receiving the query; and processing the query, using an encoder neural network, to generate the set of embedding vectors of the query in the embedding vector space.

In some implementations of the method, the k-nearest neighbors search is an exact k-nearest neighbors search.

In some implementations of the method, the k-nearest neighbors search is an approximate the k-nearest neighbors search.

In some implementations of the method, the k-nearest neighbors search is a maximum inner product search.

In some implementations of the method, for each of the plurality of data items, a respective inner product between (i) the encoded vector of the query and (ii) the respective encoded vector of the data item approximates a respective Chamfer similarity between (i) the set of embedding vectors of the query and (ii) a respective set of embedding vectors of the data item.

In some implementations, the method further includes, for each data item in the top-k subset: obtaining a respective set of embedding vectors of the data item in the embedding vector space; computing a respective Chamfer similarity between: (i) the set of embedding vectors of the query, and (ii) the respective set of embedding vectors of the data item; and determining a respective score for the data item based on the respective Chamfer similarity for the data item; ranking each data item in the top-k subset according to their respective scores; and selecting, from the top-k subset, the data item having the greatest respective score.

In some implementations of the method, for each data item in the top-k subset, obtaining the respective set of embedding vectors of the data item in the embedding vector space includes: obtaining the data item; and processing the data item, using an encoder neural network, to generate the respective set of embedding vectors of the neural network in the embedding vector space.

In some implementations of the method, encoding the set of embedding vectors of the query in the embedding vector space into the encoded vector of the query in the target vector space includes: processing the set of embedding vectors of the query, using each of one or more space partitioning functions, to generate a respective space encoded vector of the query for the space partitioning function; and concatenating the respective space encoded vectors of the query for each of the one or more space partitioning functions to generate the encoded vector of the query.

In some implementations of the method, each of the one or more space partitioning functions implements random partitioning or k-means partitioning.

In some implementations of the method, each of the one or more space partitioning functions is a locality-sensitive hash function.

In some implementations of the method, each of the one or more locality-sensitive hash functions implements SimHash partitioning.

In some implementations of the method, the one or more space partitioning functions are each associated with a respective plurality of partitions of the embedding vector space, and each of the one or more space partitioning functions is configured to: receive an input embedding vector belonging to the embedding vector space; and process the input embedding vector to assign the input embedding vector to one of the respective plurality of partitions of the embedding vector space associated with the space partitioning function.

In some implementations of the method, processing the set of embedding vectors of the query, using each of the one or more space partitioning functions, to generate the respective space encoded vector of the query for the space partitioning function includes, for each of the one or more space partitioning functions: processing each embedding vector in the set of embedding vectors of the query, using the space partitioning function, to assign the embedding vector to one of the respective plurality of partitions of the embedding vector space associated with the space partitioning function; for each of the respective plurality of partitions of the embedding vector space associated with the space partitioning function: summing each of the embedding vectors in the set of embedding vectors of the query assigned to the partition to generate a respective partition encoded vector of the query for the partition; and concatenating the respective partition encoded vectors of the query for each of the respective plurality of partitions of the embedding vector space associated with the space partitioning function to generate the respective space encoded vector of the query for the space partitioning function.

In some implementations, the method further includes, for each of the one or more space partitioning functions: applying a respective random matrix for the space partitioning function to the respective partition encoded vectors of the query for each of the respective plurality of partitions of the embedding vector space associated with the space partitioning function.

In some implementations of the method, for each of the one or more space partitioning functions, the respective random matrix for the space partitioning function has uniformly distributed entries.

In some implementations of the method, for each of the one or more space partitioning functions, the respective random matrix for the space partitioning function defines a random linear projection from the embedding vector space to another embedding vector space of lower dimensionality.

In some implementations of the method, each of the query and plurality of data items includes one or more of: a respective text sequence, a respective image, a respective video, a respective audio waveform, or a respective sensor dataset.

According to a second aspect, a system is provided. The system includes one or more non-transitory computer storage media that, when executed by one or more computers, cause the one or more computers to perform operations of the method of the first aspect in any of its aforementioned implementations.

According to a third aspect, a system is provided. The system includes: one or more computers; and one or more storage devices communicatively coupled to the one or more computers, where the one or more storage devices store instructions that, when executed by the one or more computers, cause the one or more computers to perform operations of the method of the first aspect in any of its aforementioned implementations.

Particular embodiments of the subject matter described in this specification can be implemented so as to realize one or more of the following advantages.

Neural embedding models have become a fundamental component of modern information retrieval pipelines. These models typically produce a single embedding vector x∈ [symbol] ^{d} per data item, allowing for fast retrieval via highly optimized maximum inner product search (“MIPS”) algorithms. Recently, multi-vector models, which produce a set of embedding vectors per data item, have achieved markedly superior performance for information retrieval tasks. However, using multi-vector models for information retrieval is computationally expensive due to the increased complexity of multi-vector retrieval and scoring.

To overcome these abovementioned challenges, this specification introduces a multi-vector retrieval system implementing a Multi-Vector Retrieval Algorithm (or “MUVERA”)—a retrieval mechanism which reduces multi-vector similarity search to single-vector similarity search. For example, after encoding a set of embedding vectors of a query into a single encoded vector, the multi-vector retrieval system can perform a k-nearest neighbors search on a set of data items with respect to the encoded vector, e.g., using an off-the-shelf MIPS solver. The multi-vector retrieval system asymmetrically generates encoded vectors of queries and data items in the form of fixed dimensional encodings (or “FDEs”), which are vectors whose inner product approximates multi-vector similarity. These encoded vector representations are derived by the multi-vector retrieval system with high-quality ε-approximations, thus providing a single-vector proxy for multi-vector similarity with theoretical guarantees on the approximation errors.

In experiments, it was demonstrated that the encoded vectors achieved the same recall as some current state-of-the-art heuristics for multi-vector retrieval, while retrieving fewer candidates. Compared to these state-of-the-art implementations, the multi-vector retrieval system realized consistently high end-to-end recall and latency across a diverse set of the Benchmarking Information Retrieval (“BEIR”) tasks and datasets, e.g., attaining an average of 10% improved recall with 90% lower latency in the experiments.

To summarize, in information retrieval (“IR”), single-vector and multi-vector approaches refer to how queries and data items (e.g., documents, images, products, etc.) are represented for the purpose of computing relevance or similarity. These vector representations are often used in dense information retrieval pipelines, e.g., where neural network models embed queries and data items into a continuous vector space.

For single-vector information retrieval, each data item and each query is encoded into a single respective embedding vector. Retrieval is performed by computing a similarity score, e.g., a dot product or cosine similarity, between the query and item embedding vectors. Some advantages of singe-vector information retrieval are that vector indexes, e.g., Hierarchical Navigable Small World (“HNSW”) and Inverted File Index (“IFV”), enable fast and efficient approximate nearest neighbor (“ANN”) search, e.g., supporting sublinear time on large corpora. However, since a single vector is utilized to capture all relevant information of a data item, the similarity score can fail as a measure for relevancy, especially for data items hosting dense information, e.g., high-resolution images, videos, or complex documents.

For multi-vector information retrieval, each data item each query is encoded into a respective set of embedding vectors. Retrieval is performed by computing multi-vector interaction mechanisms, often involving late interaction, e.g., max pooling, sum over dot products, or Chamfer similarity. Some advantages of multi-vector retrieval are that it has higher expressiveness and accuracy over single-vector retrieval. For example, multi-vector retrieval can have significantly higher recall than single-vector retrieval while preserving local token-level or phrase-level semantics, e.g., enabling fine-grained matching such as exact term hits, named entities, and rare words. However, since multiple vectors are utilized to capture dense, fine-grained information, the computational cost of retrieving one or more data items relevant to a query can be prohibitively expensive, both in computational time and resources, e.g., storage and processors. This is compounded by the fact that multi-vector search has, at least currently, little or no algorithms with provable approximation guarantees in either speed or accuracy, further limiting its broad application.

In light of this, the multi-vector retrieval system described herein solves the problems of both single- and multi-vector retrieval simultaneously, while maintaining the separate advantages of each. Particularly, the multi-vector retrieval system employs multi-vector representations of queries and data items to capture the nuanced information that would otherwise be missed by single-vector representations, facilitating significantly higher accuracy over single-vector search with minimal overhead. Further, the multi-vector retrieval system overcomes the computational cost of multi-vector search by transforming the multi-vector representations into fixed dimensional encodings, which can be searched using approximate nearest neighbor search techniques typically reserved for single-vector search, facilitating significantly higher efficiency over current methods for multi-vector search. For example, as shown in the experiments, the multi-vector retrieval system attained markedly higher recall and lower latency on BEIR when compared to current state-of-the-art information retrieval engines, e.g., the PLAID retrieval engine utilized by ColBERTv2.

Further still, the multi-vector retrieval system can perform this process in a manner that is theoretically principled and data-oblivious, that is, where the approximation to multi-vector search via single-vector search has provable approximation guarantees on both speed and accuracy for any data modality of the query and data items, e.g., including single-modal and multi-modal information retrieval. For example, in some implementations, the multi-vector retrieval system supports search algorithms with sublinear search time and ε-approximate search accuracy. In these cases, the multi-vector retrieval system can compute a single-vector similarity of a data item with a query that is at most the from the multi-vector similarity of the data item with the query. Thus, the multi-vector retrieval system can be optimized for the multi-vector information retrieval task with guarantees on a minimum search accuracy, a maximum search time, or both.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1C are schematic diagrams depicting an example of a multi-vector retrieval system configured to perform a multi-vector information retrieval task via fixed dimensional encodings (or “FDEs”).

FIG. 2A is a flow diagram of an example process for encoding a source dataset include a set of data items into an encoded dataset including fixed dimensional encodings of the data items.

FIG. 2B is flow diagram of an example process for retrieving a top-k subset of data items in a source dataset responsive to a query using fixed dimensional encodings thereof.

FIG. 2C is flow diagram of an example process for re-ranking the top-k subset of data items via multi-vector similarity scoring, e.g., Chamfer similarity scoring.

FIG. 3A is a schematic diagram depicting an example of a multi-to-single vector encoder configured to encode a set of embedding vectors in embedding vector space into an encoded vector in a target vector space.

FIG. 3B is a schematic diagram depicting an example of a space partitioning function of the multi-to-single vector encoder.

FIG. 4 is a flow diagram of an example process for encoding a set of embedding vectors representing a query or data item in an embedding vector space into an encoded vector representing the set of the embedding vectors of the query or data item in a target vector space.

FIGS. 5A-5C are experimental plots showing FDE recall versus dimension for varying FDE parameters on the MS MARCO dataset.

FIGS. 6A-6D are experimental plots showing comparisons of FDE recall versus brute-force search over Chamfer similarity.

FIGS. 7A-7D are experimental plots showing FDE retrieval versus a single-value Heuristic, both with and without document ID deduplication.

FIGS. 8A-8C are experimental plots showing queries per second (“QPS”) versus Recall@100 for MUVERA on a subset of the BEIR datasets.

FIGS. 9A-9B are bar plots showing latency and Recall@k of MUVERA versus PLAID on a subset of the BEIR datasets.

Like reference numbers and designations in the various drawings indicate like elements.

### DETAILED DESCRIPTION

The use of neural embeddings for representing data has become a prominent tool for information retrieval, among many other data processing tasks such as clustering and classification. Recently, multi-vector representations for information retrieval tasks have demonstrated significantly improved performance over single-vector representations, e.g., when evaluated on industry-standard information retrieval benchmarks such as BEIR. Many state-of-the-art neural embedding models produce a set of embedding vectors per query or data item, e.g., by generating one embedding per text token. The query-item similarity can then be scored via the Chamfer similarity, also referred to as the “MaxSim” operation, between the two sets of embedding vectors. These multi-vector representations can have many advantages over their single-vector counterparts, such as better interpretability and generalization.

Despite these advantages, multi-vector retrieval is more computationally expensive than single-vector retrieval. For example, producing one embedding per text token increases the number of embeddings for a dataset by orders of magnitude. Moreover, due to the non-linearity of Chamfer similarity scoring, there is a lack of optimized systems for multi-vector retrieval. Single-vector retrieval is typically accomplished via Maximum Inner Product Search (“MIPS”) algorithms. These search algorithms have been highly optimized and, therefore, can be performed in a computationally efficient manner with minimal latency. However, single-vector MIPS is usually incompatible with multi-vector retrieval. For example, in certain implementations, the multi-vector similarity between a query and a data item is the summation of the single-vector similarities of each embedding vector of the query to the nearest embedding vector of the data item. Thus, a document containing a text token with high similarity to a single text token of a query may not have high similarity to the query overall.

One approach to multi-vector retrieval is to employ a multi-stage pipeline beginning with single-vector MIPS. A version of this approach for text-based retrieval is as follows. In the initial stage, the most similar document tokens are found for each of the query tokens using single-vector MIPS. Then, the corresponding documents containing these tokens are gathered and rescored with the original Chamfer similarity. This method is referred to herein as the “single-vector heuristic”. ColBERTv2 and its optimized retrieval engine PLAID are based on this method, with the addition of several intermediate stages of pruning. Particularly, PLAID employs a four-stage retrieval and pruning process to gradually reduce the number of final candidates to be scored. Unfortunately, as described above, employing single-vector MIPS on individual query embeddings can fail to find the true multi-vector nearest neighbors. Additionally, this process is computationally expensive, since it involves querying a significantly larger MIPS index for each query embedding, e.g., larger because there are multiple embeddings per document. Finally, these multi-stage pipelines are complex and can be sensitive to parameter setting, e.g., making them difficult to tune.

To overcome these abovementioned challenges, this specification introduces a multi-vector retrieval system designed with fast, efficient, and generalized multi-vector retrieval algorithms, e.g., bridging the gap between single-vector and multi-vector information retrieval. The multi-vector retrieval system implements a Multi-Vector Retrieval Algorithm (or “MUVERA”), a retrieval mechanism which reduces multi-vector similarity search to single-vector similarity search. For example, in some implementations, the retrieval mechanism is derivable from a lightweight and provably correct reduction to single-vector MIPS-based search. Broadly, the multi-vector retrieval system employs a fast, data-oblivious transformation from a set of embeddings vectors to a single encoded vector, allowing for single-vector search and retrieval via highly optimized k-nearest neighbor (“KNN”) search solvers, e.g., MIPS solvers. Upon reducing the data set to the top-k most similar data items, the multi-vector retrieval system can then re-rank the top-k subset using Chamfer similarity scoring on their respective multi-vector representations.

Particularly, the multi-vector retrieval system transforms query (Q) and item (P) multi-vector embedding representations Q, P & [symbol] ^{d} into single, fixed-dimensional encoded vectors \vec{q}, \vec{p}∈ [symbol] ^{d}^{_{FDE}}, referred to as fixed dimensional encodings (or “FDEs”), e.g., such that the inner product [symbol] \vec{q}, \vec{p} [symbol] between the encoded vectors approximates the Chamfer similarity between Q and P. The multi-vector retrieval system performs a principled method of multi-vector information retrieval via a single-vector retrieval proxy, e.g., where the FDEs have provably strong approximation guarantees. Thus, the multi-vector retrieval system can be implemented with provable guarantees for Chamfer similarity search with strictly faster than brute-force runtime, e.g., sublinear runtime.

In offline experiments, it was demonstrated that information retrieval with respect to the FDE inner product significantly outperformed the single-vector heuristic at recovering the Chamfer similarity nearest neighbors. For example, on the MS MARCO dataset, the FDEs had a Recall@N surpassing the Recall@2-5N achieved by the single-vector heuristic while scanning a similar total number of floats in the search. For reference, Recall@N measures the proportion of relevant items that are successfully retrieved in the top-N results returned, stated succinctly as:

$$Recall @ N = \frac{\# relevant items in top N subset}{total \# relevant items in dataset} .$$

Recall@N answers the question: “Out of all the relevant items, how many did I find in the top-N results?” Similarly, Recall@2-5N refers to the recall measured between ranks 2N and 5N.

In online experiments, the end-to-end retrieval performance of the multi-vector retrieval system was compared against PLAID on several of the Benchmarking Information Retrieval (“BEIR”) tasks and datasets, including the well-studied MS MARCO dataset. As shown in the online experiments, the multi-vector retrieval system demonstrated robust and efficient retrieval. Across the datasets evaluated, the multi-vector retrieval system obtained an average of 10% higher recall, while involving 90% lower latency on average compared with PLAID. Particularly, the multi-vector retrieval system incorporated a vector compression technique called “product quantization” (or “PQ”) that enabled compression of the FDEs by thirty-two times (e.g., storing 10240-dimensional FDEs using 1280 bytes), while incurring negligible quality loss. For example, product quantization allows the multi-vector retrieval system to be implemented with a significantly smaller memory footprint compared to some systems for multi-vector retrieval.

These and other features relating to the multi-vector retrieval system described herein are described in more detail below.

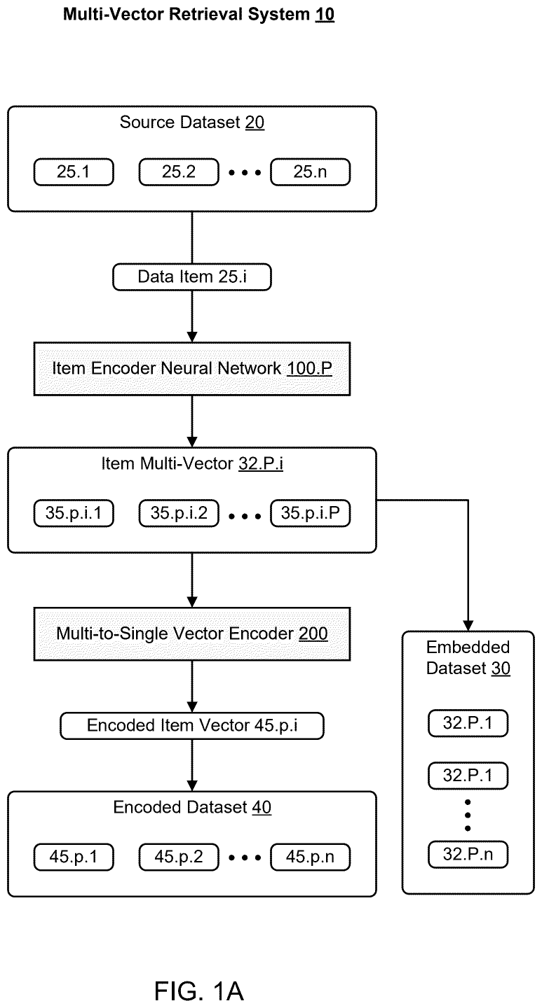

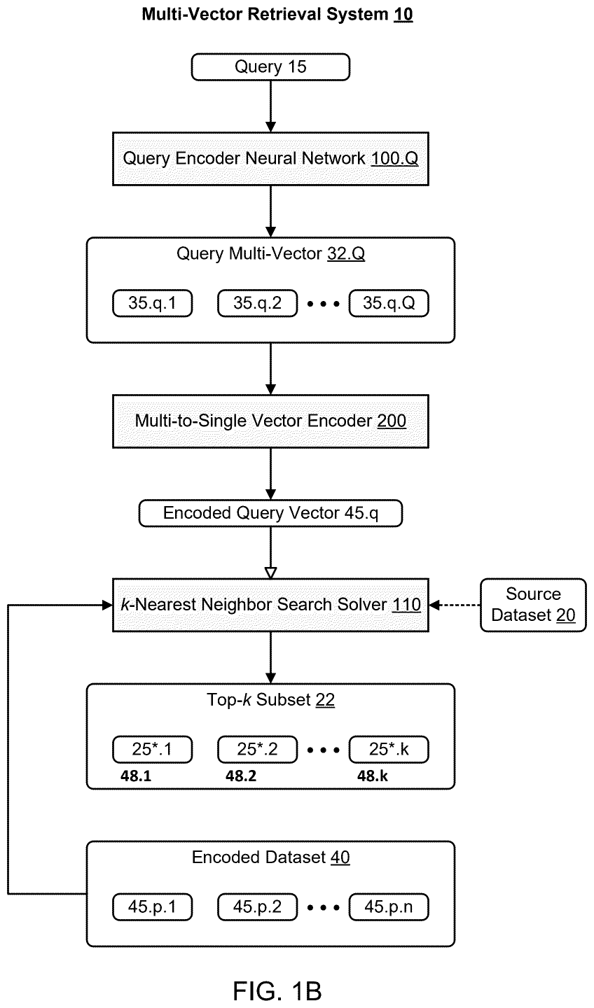

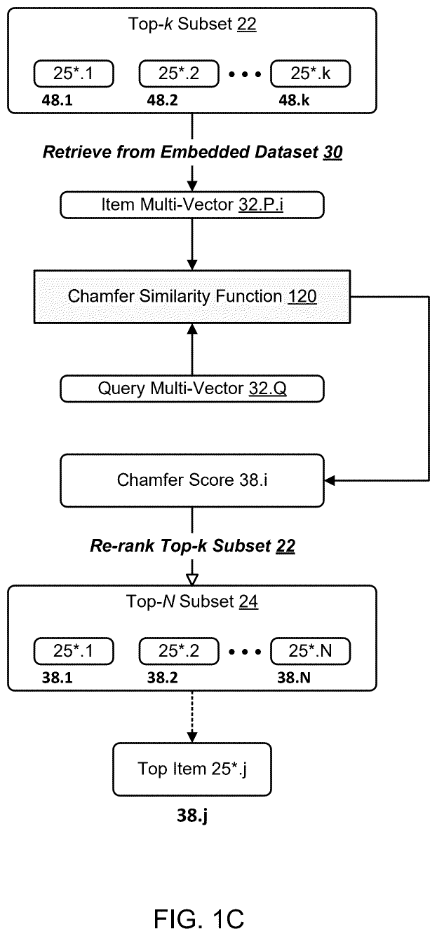

FIGS. 1A-1C are schematic diagrams depicting an example of a multi-vector retrieval system 10 configured to perform an information retrieval task via fixed dimensional encodings (or “FDEs”). The multi-vector retrieval system 10 is an example of a system implemented as computer programs on one or more computers in one or more locations in which the systems, components, and techniques described below are implemented.

As shown in FIGS. 1A-1C, the multi-vector retrieval system 10 includes an item encoder neural network 100.P, a query encoder neural network 100.Q, a multi-to-single vector encoder 200, a k-nearest neighbor solver 110, and a Chamfer similarity function 120.

Referring first to FIG. 1A, the multi-vector retrieval system 10 is configured to reference (or maintain) a source dataset 20, an embedded dataset 30, and an encoded dataset 40. For example, the source 20, embedded 30, and encoded 40 datasets can each be stored on one or more remote databases and the multi-vector retrieval system 10 can store pointers to the datasets 20, 30, and 40 on local memory. Alternatively, the multi-vector retrieval system 10 can store the datasets 20, 30, and 40 on one or more local databases and directly access the datasets 20, 30, and 40.

In some implementations, the multi-vector retrieval system 10 is part of a database management system that includes the one or more remote or local databases storing the datasets 20, 30, and 40. Here, in response to a query 15, the multi-vector retrieval system 10 is configured to retrieve a top-N subset 24 of data items 25*.1-N from the one or more remote or local databases that are relevant to the query 15. In some implementations, the query 15 indicates the top-N subset 24 of data items 25*.1-N that is to be retrieved by the multi-vector retrieval system 10.

The source dataset 20 provides the information that can be retrieved by the multi-vector retrieval system 10. Each data item 25.i in the source dataset 20 has a respective index and is retrievable from the source dataset 20 according to its index. Here, i indexes each data item 25.i in the source dataset 20, and n is the total number of data items 25 in the source dataset 20. For example, the source dataset 20 can include at least about 100, 1,000, 10,000, 100,000, 1,000,000, 10,000,000, 100,000,000, or more data items 25. The source dataset 20 may or may not include duplicate data items 25. For example, the source dataset 20 can be a non-deduplicated dataset, e.g., a dataset that has not been pre-processed to remove any duplicate data items 25 if they exist. The source dataset 20 can be a deduplicated dataset, e.g., a dataset that has been pre-processed to remove any duplicate data items 25 if they exist.

In some implementations, the multi-vector retrieval system 10 is provided with (or has access to) the source dataset 20. In some implementations, the multi-vector retrieval system 10 is configured to retrieve the source dataset 20, e.g., from an online repository.

The embedded dataset 30 provides an embedded representation of the source dataset 20 in an embedding vector space 130 of the multi-vector retrieval system 10. The embedding vector space 130, given as [symbol] ^{d}, is a real vector space having a dimension of d. For example, the embedding vector space 130 can be a real vector space having a dimension of at least about 2, 4, 8, 16, 32, 64, 128, 256, 512, 1024, 2048, or more. Broadly, the embedding vector space 130 is a latent vector space where the information of the source dataset 20 is encoded as geometric information, e.g., where similar (e.g., semantically similar) data items are mapped to nearby embedding vectors.

The embedded dataset 30 includes, for each data item 25.i in the source dataset 20, a respective set 32.P.i of embedding vectors 35.p.i.1-P representing the data item 25.i in the embedding vector space 130. The set 32.P.i of embedding vectors 35.p.i.1-P of the data item 25.i, given as Pᵢ⊂ [symbol] ^{d}, is a multi-vector representation of the data item 25.i in the embedding vector space 130. For example, each embedding vector 35.p.i.v in the set 32.P.i, given as pᵥ∈Pᵢ, can represent local semantic information of the data item 25.i in the embedding vector space 130. Here, v indexes each embedding vector 35.p.i.v in the set 32.P.i of embedding vectors 35.p.i.1-P, and |Pᵢ| is the total number of embedding vectors 35.p.i in the set 32.P.i. For example, the set 32.P.i of embedding vectors 35.p.i.1-P of the data item 25.i can include at least about 5, 10, 15, 20, 25, 50, 100, 200, 300, 400, 500, 1,000, or more individual embedding vectors 35.p.i.

In some implementations, the multi-vector retrieval system 10 is provided with (or has access to) the embedded dataset 30.

In some implementations, the multi-vector retrieval system 10 is configured to generate the embedded dataset 30 by encoding the source dataset 20 into the embedded dataset 30.

Here, for each data item 25.i in the source dataset 20, the multi-vector retrieval system 10 is configured to: receive the data item 25.i; and process the data item 25.i, using the item encoder neural network 100.P, to generate the respective set 32.P.i of embedding vectors 35.p.i.1-P of the data item 25.i in the embedded dataset 30.

In general, the item encoder neural network 100.P can have any appropriate neural network architecture that enables it to perform its described function, i.e., processing a data item 25 to generate a set 32.P of embedding vectors 35.p representing the data item 25 in the embedding vector space 130. That is, the item encoder neural network 100.P can include any appropriate types of neural network layers (e.g., fully-connected layers, convolutional layers, recurrent layers, attention layers, etc.) in any appropriate numbers (e.g., 5 layers, 25 layers, or 100 layers) and connected in any appropriate configuration (e.g., as a linear sequence of layers, a residual configuration, etc.). For example, the item encoder neural network 100.P can be a convolutional neural network (“CNN”) such as a two-dimensional CNN (“2D-CNN”) or a three-dimensional CNN (“3D-CNN”), a recurrent neural network (“RNN”), a hybrid CNN-RNN, an attention neural network (“ANN”), a graph neural network (“GNN”), or a Transformer-based neural network such as a Vision Transformer (“ViT”) neural network or a Video Vision Transformer (“ViViT”) neural network in implementations when the data item 25 is an image or a video, respectively.

The encoded dataset 40 provides an encoded representation of the embedded dataset 30 in a target vector space 140 of the multi-vector retrieval system 10. The target vector space 140, given as [symbol] ^{d}^{_{FDE}}, is a real vector space having a dimension of d_{FDE}. For example, the target vector space 140 can be a real vector space having a dimension of at least about 2, 3, 4, 5, 10, 100, 1000, 10,000, 100,000 1,000,000, or more. Typically, the target vector space 140 has higher dimensionality than the embedding vector space 130. For example, the dimension of the target vector space 140 can be at least about 2, 3, 4, 5, 10, 20, 30, 40, 50, 100, 1,000, or more times greater than the dimension of the embedding vector space 130. Broadly, the target vector space 140 is a latent vector space where the geometric information of the embedded dataset 30 is encoded, at least partially, as taxonomic information, e.g., where nearby embedding vectors are mapped to the same cluster.

The encoded dataset 40 includes, for each data item 25.i in the source dataset 20, a respective encoded vector 45.p.i representing the respective set 32.P.i of embedding vectors 35.p.i.1-P of the data item 25.i in the target vector space 140. The encoded vector 45.p.i of the data item 25.i, given as \vec{p}ᵢ∈ [symbol] ^{d}^{_{FDE}}, is a fixed dimensional encoding of the multi-vector representation of the data item 25.i. In other words, although a given size |Pᵢ| of a set 32.P.i of embedding vectors 35.p.i is variable between different ones of the sets 32.P.1-n, the dimension d_{FDE} of the encoded vector 45.p.i is fixed for each of the sets 32.P.1-n.

In some implementations, the multi-vector retrieval system 10 is provided with (or has access to) the encoded dataset 40.

In some implementations, the multi-vector retrieval system 10 is configured to generate the encoded dataset 40 by encoding the embedded dataset 30 into the encoded dataset 40.

Here, for each set 32.P.i of embedding vectors 35.p.i.1-P in the embedded dataset 30, the multi-vector retrieval system 10 is configured to: receive the set 32.P.i of embedding vectors 35.p.i.1-P; and process the set 32.P.i of embedding vectors 35.p.i.1-P, using the multi-to-single vector encoder 200, to generate the respective encoded vector 45.p.i in the encoded dataset 40.

Referring now to FIG. 1B, the multi-vector retrieval system 10 is configured to: receive a query 15 as input; and in response to receiving the query 15, retrieve, from the source dataset 20, a top-k subset 22 of the set of data items 25*.1-k relevant to the query 15. For example, the multi-vector retrieval system 10 can receive the query 15 as input from a user or a system, where the query 15 specifies an information need of the user or system. Responsive to the query 15, the multi-vector retrieval system 10 can retrieve the top-k subset 22 of data items 25*.1-k from the source dataset 20 likely to satisfy the information need of the user or system.

In more detail, the multi-vector retrieval system 10 is configured to process the query 15, using the query encoder neural network 100.Q, to generate a set 32.Q of embedding vectors 35.q.1-Q representing the query 15 in the embedding vector space 130. The set 32.Q of embedding vectors 35.q.1-Q of the query 15, given as Q⊂ [symbol] ^{d}, is a multi-vector representation of the query 15 in the embedding vector space 130. For example, each embedding vector 35.q.v in the set 32.Q, given as qᵥ∈Q, can represent local semantic information of the query 15 in the embedding vector space 130. Here, v indexes each embedding vector 35.q.v in the set 32.Q of embedding vectors 35.q.1-Q, and |Q| is the total number of embedding vectors 35.q in the set 32.Q. For example, the set 32.Q of embedding vectors 35.q.1-Q of the query 15 can include at least about 5, 10, 15, 20, 25, 50, 100, 200, 300, 400, 500, 1,000, or more individual embedding vectors 35.q.

In general, the query encoder neural network 100.Q can have any appropriate neural network architecture that enables it to perform its described function, i.e., processing a query 15 to generate a set 32.Q of embedding vectors 35.q representing the query 15 in the embedding vector space 130. That is, the query encoder neural network 100.Q can include any appropriate types of neural network layers (e.g., fully-connected layers, convolutional layers, recurrent layers, attention layers, etc.) in any appropriate numbers (e.g., 5 layers, 25 layers, or 100 layers) and connected in any appropriate configuration (e.g., as a linear sequence of layers, a residual configuration, etc.). For example, the query encoder neural network 100.Q can be a convolutional neural network (“CNN”) such as a two-dimensional CNN (“2D-CNN”) or a three-dimensional CNN (“3D-CNN”), a recurrent neural network (“RNN”), a hybrid CNN-RNN, an attention neural network (“ANN”), a graph neural network (“GNN”), or a Transformer-based neural network such as a Vision Transformer (“ViT”) neural network or a Video Vision Transformer (“ViViT”) neural network in implementations when the query 15 is an image or a video, respectively.

The multi-vector retrieval system 10 is configured to process the set 32.Q of embedding vectors 35.q.1-Q of the query 15, using the multi-to-single vector encoder 200, to generate an encoded vector 45.q representing the set 32.Q of embedding vectors 35.q.1-Q of the query 15 in the target vector space 140. The encoded vector 45.q of the query 15, given as \vec{q}∈ [symbol] ^{d}^{_{FDE}}, is a fixed dimensional encoding of the multi-vector representation of the query 15. In other words, although a given size |Q| of the set 32.Q of embedding vectors 35.q is variable, the dimension d_{FDE} of the encoded vector 45.q remains fixed for the given size.

In general, the multi-vector retrieval system 10 implements the multi-to-single vector encoder 200 to reduce a multi-vector similarity search on the embedded dataset 30 to a single-vector similarity search on the encoded dataset 40. Particularly, for a given dimension (d_{FDE}) of the target vector space 140, the multi-to-single vector encoder 200 generates random mappings of F_{q}: [symbol] → [symbol] ^{d}^{_{FDE}} for the query 15 and random mappings of Fₚ: [symbol] → [symbol] ^{d}^{_{FDE}} for the set of data items 25.1-n, such that for all the query 32.Q and item 32.P.1-n multi-vector representations, the following condition is satisfied:

$$〈 \vec{q} , {\vec{p}}_{i} 〉 \approx CHAMFER ( Q , {P}_{i} ) = {\sum }_{q ∈ Q} {max}_{p ∈ {P}_{i}} 〈 q , p 〉 , \qquad ( 1 )$$

where \vec{q}=F_{q}(Q) is the encoded vector 45.q of the query 15 and \vec{p}ᵢ=Fₚ(P) is the encoded vector 45.p.i of a data item 25.i in the source dataset 20. Here, [symbol] ⋅,⋅ [symbol] denotes the inner product, and CHAMFER denotes the Chamfer similarity function 120, also referred to as the “MaxSim” or the “relaxed earth mover distance”. Note, another advantage of the encoded vector 45 representations is that the functions F_{q} and Fₚ are data-oblivious, e.g., making them robust to distribution shifts, and easily usable in streaming settings.

According to Eq. (1), for each data item 25.i in the dataset 20, the inner product between (i) the encoded vector 45.q of the query 15 and (ii) the encoded vector 45.p.i of the data item 25.i is an approximation, e.g., an ε-additive approximation, to a Chamber similarity score 48.i between (i) the set 32.Q of embedding vectors 35.q.1-Q of the query 15 and (ii) the set 32.P.i of embedding vectors 35.p.i.1-P of the data item 25.i. The multi-to-single vector encoder 200 also provides an &-approximate solution to Chamfer similarity search using a dimension (d_{FDE}) of the target vector space 140 that depends only logarithmically on the size (n) of the source dataset 20. Particularly, since the encoded vector 45.q of the query 15 is generally sparse, the multi-vector retrieval system 10 can run an exact k-nearest neighbors search on the encoded dataset 40 in a runtime of O(|Q|n), improving on the brute-force runtime of

$$O ( \vert Q \vert {max}_{i} \vert {P}_{i} \vert n )$$

for Chamfer similarity search.

Using the k-nearest neighbors search solver 110, the multi-vector retrieval system 10 is configured to perform, with respect to the encoded vector 45.q of the query 15, a k-nearest neighbors search on the encoded dataset 40 to identify the top-k subset 22 of data items 25*.1-k from the source dataset 20. Particularly, for each data item 25*.i in the top-k subset 22, the k-nearest neighbors search returns the respective index (i) of the data item 25*.i and a respective single-vector similarity score 48.i for the data item 25*.i. The single-vector similarity score 48.i measures a similarity between: (i) the encoded vector 45.q of the query 15, and (ii) the respective encoded vector 45.i of the data item 25*.i. The multi-vector retrieval system 10 then identifies the top-k subset 22 of data items 25*.1-k in the source dataset 20 according to their respective indices i=1, 2, . . . k, and ranks them according to their respective single-vector similarity scores 48.1-k. Thus, in general, the top-k subset 22 is an ordered set of the k data items 25*.1-k from the source dataset 20 having the greatest respective single-vector similarity scores 48.1-k evaluated during the k-nearest neighbors search.

In some implementations, the k-nearest neighbors search is an exact k-nearest neighbors search. For example, the k-nearest neighbors search can be a brute-force search or a tree-based search, e.g., a k-d tree, a ball tree, a cover tree, a vantage-point tree, etc.

In some implementations, the k-nearest neighbors search is an approximate k-nearest neighbors (“ANN”) search. For example, the k-nearest neighbors search can be a DiskANN search, a Navigable Small World (“NSW”) Graph search, a Hierarchical Navigable Small World (“HNSW”) Graph search, an Inverted File Index (“IVF”) search, a SPANN search, etc.

In some implementations, e.g., for improving memory usage, the k-nearest neighbors search solver 110 uses a vector compression technique called “product quantization” (or “PQ”) when performing the approximate k-nearest neighbors search on the encoded dataset 40 to identify the top-k subset 22 of data items 25*.1-k from the source dataset 20, e.g., with asymmetric distance computation (“ADC”) with respect to the encoded vector 45.q of the query 15. For example, the approximate k-nearest neighbors search can be a DiskANN PQ search or an IFV PQ search. Here, product quantization with C centers per group of G dimensions is referred to as “PQ-C-G”. The k-nearest neighbors search solver 110 can implement a product quantizer using a “textbook” k-means based quantizer. The k-nearest neighbors search solver 110 can train the product quantizer by: (1) taking for each group of dimensions, the coordinates of a sample of the encoded vectors 45.p.1-n from the encoded dataset 40 (e.g., a sample of 100,000 vectors or less), and (2) performing k-means clustering on the sample using k=C centers until convergence. Given an encoded vector 45 \vec{x}∈ [symbol] ^{d}^{_{FDE}}, the k-nearest neighbors search solver 110 splits the encoded vector 45 \vec{x} into d_{FDE}/G blocks of encoded subvectors \vec{x}₍₁₎, . . . , \vec{x}_{(d}_{_{FDE}}_{/G)}∈ [symbol] ^{G} each having a dimension of G. The encoded subvector \vec{x}_{(g)} is compressed by representing the encoded subvector with the index of the centroid from the g-th group g∈G that is nearest to the encoded subvector \vec{x}_{(g)}. Other examples of product quantization are described by Herve Jegou, Matthijs Douze, and Cordelia Schmid, “Product quantization for nearest neighbor search,” IEEE Transactions on Pattern Analysis and Machine Intelligence 33.1 (2010): 117-128.

In some implementations, the k-nearest neighbors search is a maximum inner product search (“MIPS”). In this case, for each data item 25*.i in the top-k subset 22, the single-vector similarity score 48.i for the data item 25*.i is the inner product between the encoded vectors 45.q and 45.p.i of the query 15 and data item 25*.i, which approximates the respective Chamfer similarity score 38.i for the data item 25*.i as described above with reference to Eq. (1).

Referring lastly to FIG. 1C, the multi-vector retrieval system 10 is configured to re-rank the top-k subset 22 of data items 25*.1-k, using the Chamfer similarity function 120, to determine a top-N subset 24 of data items 25*.1-N in the source dataset 20. For clarity, the top-N subset 24 will also be referred to as the re-ranked top-k subset 22.

In more detail, for each data item 25*.i in the top-k subset 22, the multi-vector retrieval system 10 retrieves, from the embedded dataset 30, the respective set 32.P.i of embedding vectors 35.p.i.1-P of the data item 25*.i. The multi-vector retrieval system 10 then computes a respective Chamfer similarity score 38.i between: (i) the set 32.Q of embedding vectors 35.q.1-Q of the query 15, and (ii) the set 32.P.i of embedding vectors 35.p.i.1-P of the data item 25*.i. The Chamfer similarity score 38.i for a data item 25*.i in the top-k subset 22 is given as:

$$CHAMFER ( Q , {P}_{i}^{*} ) = {\sum }_{q ∈ Q} {max}_{p ∈ {P}_{i}^{*}} 〈 q , p 〉 , \qquad ( 2 )$$

where P*ᵢ is the set 32.P.i of embedding vectors 35.p.i.1-P of the data item 25*.i, and i∈k.

The multi-vector retrieval system 10 then re-ranks the top-k subset 22 of data items 25*.1-k according to their respective Chamfer similarity scores 38.1-k to determine the top-N subset 24 of data items 25*.1-N. Note, the re-ranking may involve removing one or more of the data items 25*.1-k from the top-k subset 22 if they have sufficiently low Chamfer similarity scores 38.1-k, e.g., according to a threshold similarity score. Thus, in general, the top-N subset 24 is an ordered set of the N data items 25*.1-N from the source dataset 20 having, at least approximately, the greatest respective Chamfer similarity scores 38.1-N with the query 15.

Finally, the multi-vector retrieval system 10 can select, from the top-N subset 24 of data items 25*.1-N, the data item 25*.j having the greatest respective Chamfer similarity score 38.j with the query 15. This provides the approximate solution to the Chamfer similarity search as:

$$j = arg {max}_{i ∈ k} CHAMFER ( Q , {P}_{i}^{*} ) \approx arg {max}_{i ∈ n} CHAMFER ( Q , {P}_{i} ) , \qquad ( 3 )$$

where re-ranking the top-k subset 22 of data items 25*.1-k identified from the k-nearest neighbors search approximates a Chamfer similarity search on all the multi-vector representations 32.P of the data items 25.1-n in the embedded dataset 30 with respect to the multi-vector representation 32.Q of the query 15.

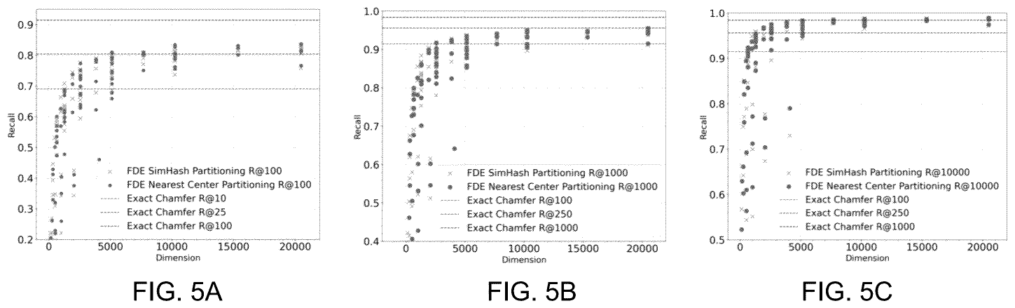

Utilizing this above procedure, the multi-vector retrieval system 10 can significantly reduce the computational resources associated with multi-vector-based information retrieval tasks, e.g., as compared to current state-of-the-art multi-vector retrieval systems such as PLAID, while remaining highly accurate with respect to the Chamfer similarity scoring. For example, in some implementations, the multi-vector retrieval system 10 can retrieve the top-N subset 24 from the source dataset 20 with a Recall@N of at least about 0.50, 0.55, 0.60, 0.65, 0.70, 0.75, 0.80, 0.85, 0.90, 0.95, or more. For any of these values of the Recall@N on the source dataset 20, the number (N) of relevant data items 25*.1-N in the top-N subset 22 can be at least about 1, 2, 3, 4, 5, 10, 15, 20, 25, 50, 100, 150, 200, 250, 300, 350, 450, 500, 750, 1000, or more. An example implementation of the multi-vector retrieval system 10, referred to as “MUVERA”, that demonstrated such performance on BEIR is described in the experiments section with reference to FIGS. 5A-9B.

The multi-vector retrieval system 10 can be implemented in any appropriate location, e.g., on a user device (e.g., a mobile device such as a smartphone, laptop, or tablet), or on one or more computers in a data center (e.g., on a cloud server running in the data center), etc. In some implementations, users can interact with the multi-vector retrieval system 10, e.g., by providing the query 15 to the multi-vector retrieval system 10 by way of an interface, e.g., a graphical user interface (“GUI”), or an application programming interface (“API”). For example, a user can provide a user input to the multi-vector retrieval system 10, where the user input includes: (i) a request to process the query 15, and (ii) the query 15. The multi-vector retrieval system 10 can process the query 15, responsive to the request, and provide the top-N subset 24 of data items 25*.1-N relevant (e.g., most relevant) to the query 15 to the user, e.g., for implementation on a user device of the user, or for storage in a data storage device. In some implementations, the multi-vector retrieval system 10 can transmit the top-N subset 24 of data items 25*.1-N to a user device of the user, e.g., by way of a data communication network (e.g., the Internet).

In general, the information retrieval task performed by the multi-vector retrieval system 10 can be any information retrieval task, and the query 15 and source dataset 20 can be of any data modality. That is, the information retrieval task can be a single-modal information retrieval task where the query 15 and source dataset 20 are of the same data modality, or a multi-modal information retrieval task where the query 15 and source dataset 20 are of different data modalities. A few examples are described below.

In some implementations, the query 15 is a text sequence, an image, a video, or an audio waveform, and the query encoder neural network 100.Q is a text encoder neural network, an image encoder neural network, a video encoder neural network, or an audio encoder neural network, respectively. In some implementations, each data item 25.i in the set of data items 25.1-n is a respective text sequence, a respective image, a respective video, or a respective audio waveform, and the item encoder neural network 100.P is a text encoder neural network, an image encoder neural network, a video encoder neural network, or an audio encoder neural network, respectively. Note here, a text sequence can refer to any sequence of text tokens such as a word, a sentence, a paragraph, or a document.

In some implementations, the information retrieval task is a text-based retrieval task, where the query 15 is an input text sequence, and the query encoder neural network 100.Q is a text encoder neural network. Here, a text sequence can refer to a sequence of text of any length, such as a text piece, a sentence, a document, or a passage.

In some of these implementations, the text-based retrieval task is a text-to-text retrieval task, where each data item 25.i in the source dataset 20 is a respective indexed text sequence, and the item encoder neural network 100.P is a text encoder neural network. For example, the query 15 can be an input text sequence describing requested information, and each data item 25*.i in the top-N subset 24 of data items 25*.1-N can be the respective indexed text sequence in the source dataset 20 likely describing the requested information.

In some of these implementations, the text-based retrieval task is a text-to-image retrieval task, where each data item 25.i in the source dataset 20 is a respective indexed image, and the item encoder neural network 100.P is an image encoder neural network. For example, the query 15 can be an input text sequence describing a scene or an object, and each data item 25*.i in the top-N subset 24 of data items 25*.1-N can be the respective indexed image in the source dataset 20 likely depicting the scene or object.

In some of these implementations, the text-based retrieval task is a text-to-video retrieval task, where each data item 25.i in the source dataset 20 is a respective indexed video, and the item encoder neural network 100.P is a video encoder neural network. For example, the query 15 can be an input text sequence describing a scene or an object, and each data item 25*.i in the top-N subset 24 of data items 25*.1-N can be the respective indexed video in the source dataset 20 likely depicting a respective motion sequence of the scene or object.

In some of these implementations, the text-based retrieval task is a text-to-audio retrieval task, where each data item 25.i in the source dataset 20 is a respective indexed audio waveform, and the item encoder neural network 100.P is an audio encoder neural network. For example, the query 15 can be an input text sequence describing a sound, and each data item 25*.i in the top-N subset 24 of data items 25*.1-N can be the respective indexed audio waveform in the source dataset 20 likely sampling the sound.

In some implementations, the information retrieval task is an image-based retrieval task, where the query 15 is an input image, and the query encoder neural network 100.Q is an image encoder neural network.

In some of these implementations, the image-based retrieval task is an image-to-text retrieval task, where each data item 25.i in the source dataset 20 is a respective indexed text sequence, and the item encoder neural network 100.P is a text encoder neural network. For example, the query 15 can be an input image depicting a scene or an object, and each data item 25*.i in the top-N subset 24 of data items 25*.1-N can be the respective indexed text sequence in the source dataset 20 likely describing the scene or object.

In some of these implementations, the image-based retrieval task is an image-to-image retrieval task, where each data item 25.i in the source dataset 20 is a respective indexed image, and the item encoder neural network 100.P is an image encoder neural network. For example, the query 15 can be an input image depicting a scene or an object in a given context, and each data item 25*.i in the top-N subset 24 of data items 25*.1-N can be the respective indexed image in the source dataset 20 likely depicting the scene or object in a different respective context.

In some of these implementations, the image-based retrieval task is an image-to-video retrieval task, where each data item 25.i in the source dataset 20 is a respective indexed video, and the item encoder neural network 100.P is a video encoder neural network. For example, the query 15 can be an input image depicting a scene or an object, and each data item 25*.i in the top-N subset 24 of data items 25*.1-N can be the respective indexed video in the source dataset 20 likely depicting a respective motion sequence of the scene or object.

In some of these implementations, the image-based retrieval task is an image-to-audio retrieval task, where each data item 25.i in the source dataset 20 is a respective indexed audio waveform, and the item encoder neural network 100.P is an audio encoder neural network. For example, the query 15 can be an input image depicting an object, and each data item 25*.i in the top-N subset 24 of data items 25*.1-N can be the respective indexed audio waveform in the source dataset 20 likely sampling a respective sound made by the object.

In some implementations, the information retrieval task is a video-based retrieval task, where the query 15 is an input video, and the query encoder neural network 100.Q is a video encoder neural network.

In some of these implementations, the video-based retrieval task is a video-to-text retrieval task, where each data item 25.i in the source dataset 20 is a respective indexed text sequence, and the item encoder neural network 100.P is a text encoder neural network. For example, the query 15 can be an input video depicting a motion sequence of a scene or an object, and each data item 25*.i in the top-N subset 24 of data items 25*.1-N can be the respective indexed text sequence in the source dataset 20 likely describing the motion sequence scene or object.

In some of these implementations, the video-based retrieval task is a video-to-image retrieval task, where each data item 25.i in the source dataset 20 is a respective indexed image, and the item encoder neural network 100.P is an image encoder neural network. For example, the query 15 can be an input video depicting a motion sequence of a scene or an object in a given context, and each data item 25*.i in the top-N subset 24 of data items 25*.1-N can be the respective indexed image in the source dataset 20 likely depicting the scene or object in a different respective context.

In some of these implementations, the video-based retrieval task is video-to-video retrieval task, where each data item 25.i in the source dataset 20 is a respective indexed video, and the item encoder neural network 100.P is a video encoder neural network. For example, the query 15 can be an input video depicting a motion sequence of a scene or an object in a given context, and each data item 25*.i in the top-N subset 24 of data items 25*.1-N can be the respective indexed video in the source dataset 20 likely depicting a respective motion sequence of the scene or object in a different respective context.

In some of these implementations, the video-based retrieval task is a video-to-audio retrieval task, where each data item 25.i in the source dataset 20 is a respective indexed audio waveform, and the item encoder neural network 100.P is an audio encoder neural network. For example, the query 15 can be an input video depicting a motion sequence of an object, and each data item 25*.i in the top-N subset 24 of data items 25*.1-N can be the respective indexed audio waveform in the source dataset 20 likely sampling a respective sound made by the object during the motion sequence.

In some implementations, the information retrieval task is an audio-based retrieval task, where the query 15 is an input audio waveform, and the query encoder neural network 100.Q is an audio encoder neural network.

In some of these implementations, the audio-based retrieval task is an audio-to-text retrieval task, where each data item 25.i in the source dataset 20 is a respective indexed text sequence, and the item encoder neural network 100.P is a text encoder neural network. For example, the query 15 can be an input audio waveform sampling a spoken utterance of information requested, and each data item 25*.i in the top-N subset 24 of data items 25*.1-N can be the respective indexed text sequence in the source dataset 20 likely describing the information spoken in the utterance.

In some of these implementations, the audio-based retrieval task is an audio-to-image retrieval task, where each data item 25.i in the source dataset 20 is a respective indexed image, and the item encoder neural network 100.P is an image encoder neural network. For example, the query 15 can be an input audio waveform sampling a sound, and each data item 25*.i in the top-N subset 24 of data items 25*.1-N can be the respective indexed image in the source dataset 20 likely depicting a respective object that made the sound.

In some of these implementations, the audio-based retrieval task is an audio-to-video retrieval task, where each data item 25.i in the source dataset 20 is a respective indexed video, and the item encoder neural network 100.P is a video encoder neural network. For example, the query 15 can be an input audio waveform sampling a sound, and each data item 25*.i in the top-N subset 24 of data items 25*.1-N can be the respective indexed video in the source dataset 20 likely depicting a respective motion sequence of an object that made the sound.

In some of these implementations, the audio-based retrieval task is an audio-to-audio retrieval task, where each data item 25.i in the source dataset 20 is a respective indexed audio waveform, and the item encoder neural network 100.P is an audio encoder neural network. For example, the query 15 can be an input audio waveform sampling a spoken utterance of information requested, and each data item 25*.i in the top-N subset 24 of data items 25*.1-N can be the respective indexed audio waveform in the source dataset 20 likely sampling a respective uttering of the information requested. As another example, the query 15 can be an input audio waveform sampling a sound made by an object, and each data item 25*.i in the top-N subset 24 of data items 25*.1-N can be the respective indexed audio waveform in the source dataset 20 likely sampling a different respective sound made by the object.

In some implementations, the information retrieval task is an information retrieval task involving sensor data derived from a set of one or more sensors, where the query 15 is of any data modality, each data item 25.i in the source dataset 20 is a respective indexed sensor dataset derived from the set of sensors, and the item encoder neural network 100.P is an encoder neural network associated with the set of sensors, e.g., an encoder neural network pre-trained on the set of sensors. The set of sensors can be a set of human activity sensors, a set of biomedical sensors, a set of automotive sensors, a set of industrial sensors, a set of Internet of Things sensors, a set of environmental monitoring sensors, a set of remote sensing sensors. For example, the set of sensors can include an accelerometer, a gyroscope, a magnetometer, a radar sensor (e.g., mmWave or LiDAR), an electrocardiogram sensor, an electroencephalogram sensor, a photoplethysmographic sensor, and so on.

In some implementations, the query 15 is a sensor dataset, and the query encoder neural network 100.Q is a sensor data encoder neural network. For example, the query 15 can be a human activity or wearable sensor dataset, a biomedical or physiological dataset.

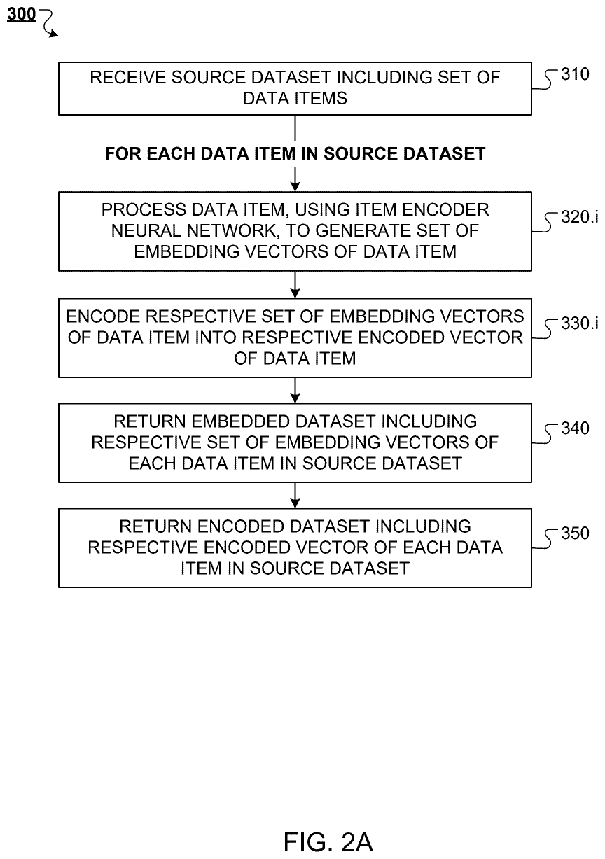

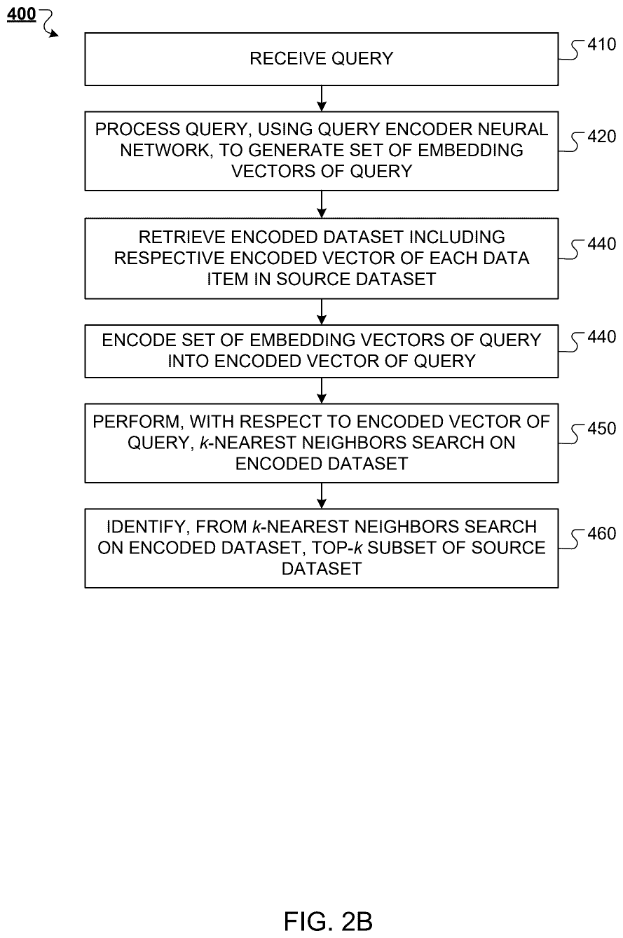

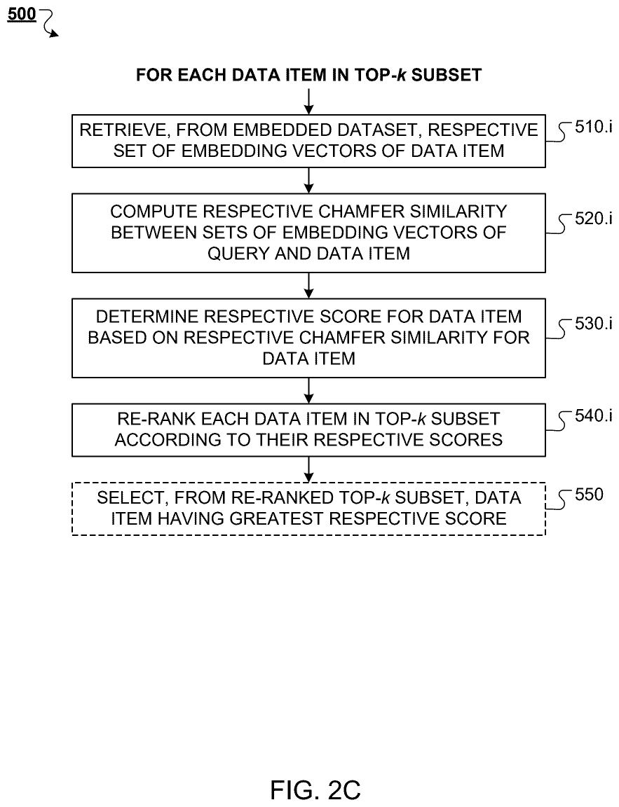

FIG. 2A is a flow diagram of an example process 300 for encoding a source dataset 20 into an embedded dataset 30, and the embedded dataset 30 into an encoded dataset 40. For convenience, the process 300 will be described as being performed by a system of one or more computers located in one or more locations. For example, a multi-vector retrieval system, e.g., the multi-vector retrieval system 10 of FIGS. 1A-1C, appropriately programmed in accordance with this specification, can perform the process 300.

The multi-vector retrieval system 10 receives the source dataset 20 including a set of data items 25.1-n (310).

For each data item 25.i in the source dataset 20:

The multi-vector retrieval system 10 processes the data item 25.i, using an item encoder neural network 100.P, to generate a respective set 32.P.i of embedding vectors 35.p.i.1-P representing the data item 25.i in an embedding vector space 130 (320.i).

The multi-vector retrieval system 10 encodes the set 32.P.i of embedding vectors 35.p.i.1-P of the data item 25.i into a respective encoded vector 45.p.i representing the set 32.P.i of embedding vectors 35.p.i.1-P of the data item 25.i in a target vector space 140 (330.i). For example, the multi-vector retrieval system 10 can process the set 32.P.i of embedding vectors 35.p.i.1-P of the data item 25.i, using a multi-to-single vector encoder 200, to generate the encoded vector 45.p.i of the data item 25.i.

The multi-vector retrieval system 10 returns the embedded dataset 30 including, for each data item 25.i in the source dataset 20, the respective set 32.P.i of embedding vectors 35.p.i.1-P representing the data item 25.i in the embedding vector space 130 (340).

The multi-vector retrieval system 10 returns the encoded dataset 40 including, for each data item 25.i in the source dataset 20, the respective encoded vector 45.p.i representing the respective set 32.P.i of embedding vectors 35.p.i.1-P of the data item 25.i in the target embedding space 140 (350).

FIG. 2B is a flow diagram of an example process 400 for retrieving a top-k subset 22 of data items 25*.1-k from the source dataset 20 responsive to a query 15. For convenience, the process 400 will be described as being performed by a system of one or more computers located in one or more locations. For example, a multi-vector retrieval system, e.g., the multi-vector retrieval system 10 of FIGS. 1A-1C, appropriately programmed in accordance with this specification, can perform the process 400.

The multi-vector retrieval system 10 receives the query 15 (410).

The multi-vector retrieval system 10 processes the query 15, using a query encoder neural network 100.Q, to generate a set 32.Q of embedding vectors 32.q.1-Q representing the query 15 in the embedding vector space 130 (420).

The multi-vector retrieval system 10 retrieves the encoded dataset 40 including, for each data item 25.p.i in the source dataset 20, the respective encoded vector 25.p.i representing the data item 25.p.i in the target vector space 140 (430).

The multi-vector retrieval system 10 encodes the set 32.Q of embedding vectors 32.q.1-Q representing the query 15 in the embedding vector space 130 into an encoded vector 45.q representing the set 32.Q of embedding vectors 32.q.1-Q of the query 15 in the target vector space 140 (440). For example, the multi-vector retrieval system 10 can process the set 32.Q of embedding vectors 35.q.1-Q of the query 15, using the multi-to-single vector encoder 200, to generate the encoded vector 45.q of the query 15.

The multi-vector retrieval system 10 performs, with respect to the encoded vector 45.q of the query 15, a k-nearest neighbors search on the encoded dataset 40 (450). For example, the multi-vector retrieval system 10 can use a k-nearest neighbors search solver 110 to perform the k-nearest neighbors search on the encoded dataset 40.

The multi-vector retrieval system 10 identifies, from the k-nearest neighbors search on the encoded dataset 40, the top-k subset 22 of data items 25*.1-k from the source dataset 20 (460).

FIG. 2C is a flow diagram of an example process 500 for re-ranking the top-k subset 22 of data items 25*.1-k via Chamfer similarity scoring. For convenience, the process 500 will be described as being performed by a system of one or more computers located in one or more locations. For example, a multi-vector retrieval system, e.g., the multi-vector retrieval system 10 of FIGS. 1A-1C, appropriately programmed in accordance with this specification, can perform the process 400.

For each data item 25*.i in the top-k subset 22:

The multi-vector retrieval system 10 retrieves, from the embedded dataset 30, the respective set 32.P.i of embedding vectors 35.p.i.1-P of the data item 25.i (510.i).

The multi-vector retrieval system 10 computes a respective Chamfer similarity between: (ii) the set 32.Q of embedding vectors 35.q.i.1-Q, and (ii) the set 32.P.i of embedding vectors 35.p.i.1-P of the data item 25*.i (520.i).

The multi-vector retrieval system 10 determines a respective score 38.i for the data item 25*.i based on the respective Chamfer similarity for the data item 25*.i (530.i). For example, the score 38.i for the data item 25*.i can be a Chamfer similarity score, that is, the score 38.i can be the Chamfer similarity for the data item 25*.i itself or proportional to the Chamfer similarity. As another example, the score 38.i for the data item 25*.i can be

The multi-vector retrieval system 10 re-ranks the data items 25*.1-k in the top-k subset 22 according to their respective scores 38.1-k (540).

In some implementations of the process 400, the multi-vector retrieval system 10 selects, from the re-ranked top-k subset 24, the data item 21*.j having the greatest respective score 38.j based on the respective Chamfer similarity (550).

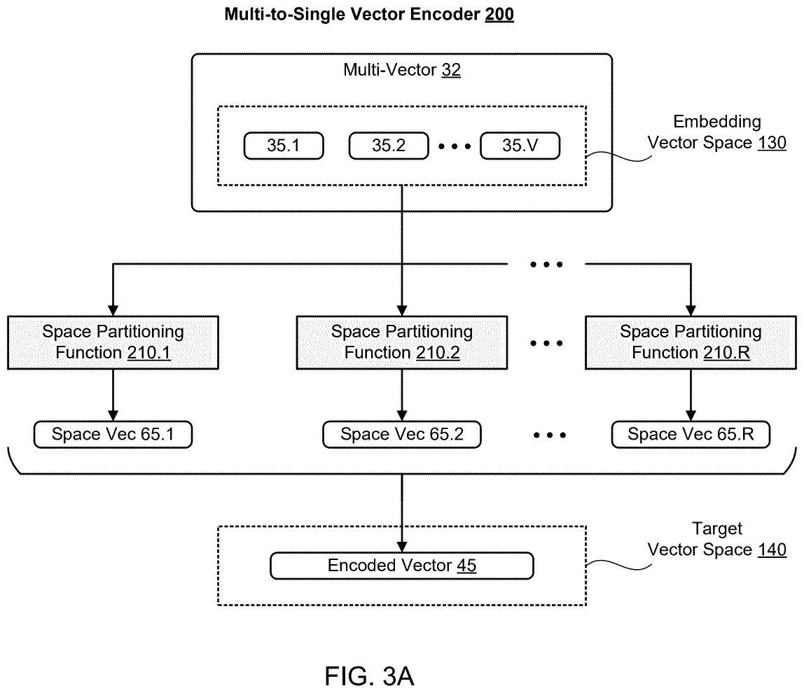

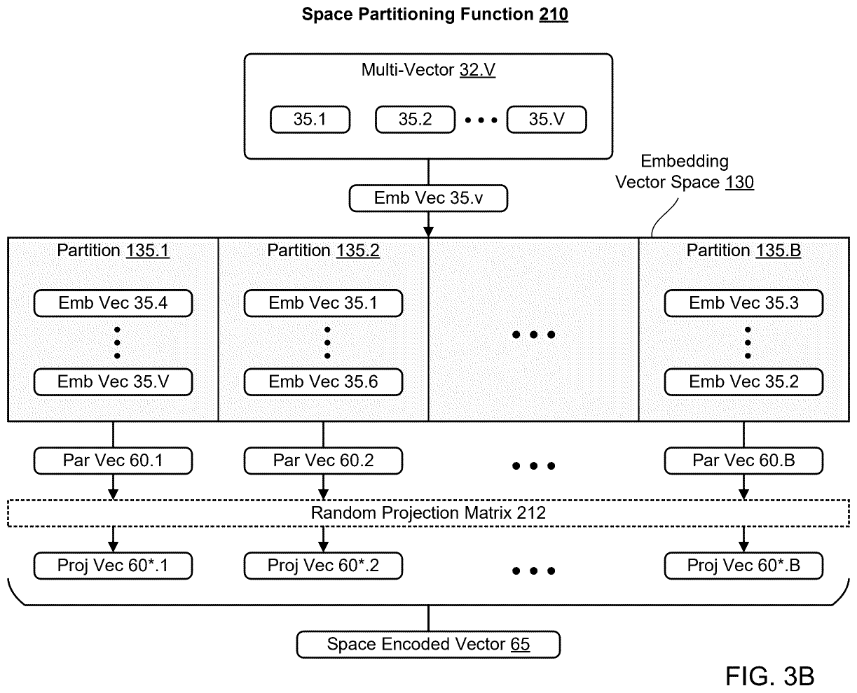

FIG. 3A is a schematic diagram depicting an example of the multi-to-single vector encoder 200 configured to encode a set 32.V of embedding vectors 35.1-V in the embedding vector space 130 into an encoded vector 45 in the target vector space 140.

As mentioned above, the multi-to-single vector encoder 200 is implemented by the multi-vector retrieval system 10 to generate the random mappings of F_{q}: [symbol] → [symbol] ^{d}^{_{FDE}} for the query 15 and the random mappings of Fₚ: [symbol] → [symbol] ^{d}^{_{FDE}} for the set of data items 25.1-n. Particularly, as shown in Eqs. (1)-(3), the multi-to-single vector encoder 200 is configured to generate the random mappings such that the k-nearest neighbors search on the encoded dataset 40 provides an approximate solution, e.g., an ε-approximate solution, to a Chamfer similarity search on the embedded dataset 30. The intuition behind the multi-to-single vector encoder 200 is as follows. If the optimal mapping π: Q→P between a query multi-vector representation 32.Q and an item multi-vector representation 32.P in which to match them was known, the multi-to-single vector encoder 200 could create query 45.q and item 45.p encoded vectors \vec{q}, \vec{p} by concatenating all the embedding vectors 35.1-Q in Q and their respective images in P together, such that the inner product between the encoded vectors 45.q and 45.p provides:

$$〈 \vec{q} , \vec{p} 〉 = {\sum }_{q ∈ Q} 〈 q , π ( q ) 〉 = CHAMFER ( Q , P ) . \qquad ( 4 )$$

However, since the optimal mapping (π) is not known a priori, and since different query-item multi-vector pairs 32.Q and 32.P.i have different optimal mappings, this type of concatenation generally fails. Instead, the multi-to-single vector encoder 200 finds a randomized ordering over all the embedding vectors 35 in the embedding vector space ( [symbol] ^{d}) 130, such that, after clustering nearby embedding vectors 35 together, the inner product of any query-item multi-vector pair Q, Pᵢ⊂ [symbol] ^{d} concatenated into a query-item encoded vector pair \vec{q}, \vec{p}ᵢ∈ [symbol] ^{d}^{_{FDE}} under this ordering approximates the Chamfer similarity score 38.i.

To accomplish this, the multi-to-single vector encoder 200 includes a set of one or more space partitioning functions 210.1-R. Each space partitioning function 210.r, given as φᵣ: [symbol] ^{d}→[B]ᵣ, is associated with a respective set of partitions 135.r.1-B of the embedding vector space 130. The set of partitions 135.r.1-B of the embedding vector space 130, given as [B]ᵣ, denotes the respective partitioning representation of the space partitioning function 210.r. Note, the set of partitions 135.r.1-B may also be referred to as a set of “clusters” of the embedding vector space 130. Here, r indexes each space partitioning function 210.r in the set of space partitioning functions 210.1-R, b indexes each partition 135.r.b in the respective set of partitions 135.r.1-B associated with the space partitioning function 210.r, B is the total number of partitions 135.r in the set of partitions 135.r.1-B, and R is the total number of space partitioning functions 210 in the set of space partitioning functions 210.1-R. For example, the set of space partitioning functions 210.1-R can include at least about 1, 2, 3, 4, 5, 6, 7, 8, 9, 10, 15, 20, 25, 50, 75, 100, 150, 200, 250, 500 or more space partitioning functions 210. As another example, the respective set of partitions 135.r.1-B associated with each space partitioning function 210.r can include at least about 5, 10, 15, 20, 25, 50, 75, 100, 150, 200, 250, 500 or more partitions 135.r of the embedding vector space 130.

To generate the encoded vector 45.q of the query 15, the multi-to-single vector encoder 200 is configured to perform the following operations:

The multi-to-single vector encoder is configured to: receive the set 32.Q of embedding vectors 35.q.1-Q representing the query 15 in the embedding vector space 130; and process the set 32.Q of embedding vectors 35.q.1-Q of the query 15, using each space partitioning function 210.r, to generate a respective space encoded vector (\vec{q}ᵣ) 65.q.r of the query 15 for the space partitioning function 210.r. Then, the multi-to-single vector encoder 200 is configured to concatenate the respective space encoded vectors 65.q.1-R of the query 15 for each of the space partitioning functions 210.1-R to generate the encoded vector 45.q representing the query 15 in the target vector space 140. Thus, the encoded vector 45.q of the query 15, given as \vec{q}=(\vec{q}₁, . . . , \vec{q}_{R}), is a block vector including the respective space encoded vectors 65.q.1-R of the query 15 for each of the space partitioning functions 210.1-R.

To generate the encoded vector 45.p of a data item 25, the multi-to-single vector encoder 200 is configured to perform the following operations:

The multi-to-single vector encoder 200 is configured to: receive the set 32.P of embedding vectors 35.p.1-P representing the data item 25 in the embedding vector space 130; and process the set 32.P of embedding vectors 35.p.1-P of the data item 25, using each space partitioning function 210.r, to generate a respective space encoded vector (\vec{p}ᵣ) 65.p.r of the data item 25 for the space partitioning function 210.r. Then, the multi-to-single vector encoder 200 is configured to concatenate the respective space encoded vectors 65.p.1-R of the data item 25 for each of the space partitioning functions 210.1-R to generate the encoded vector 45.P representing the data item 25 in the target vector space 140. Thus, the encoded vector 45.p of the data item 25, given as \vec{p}=(\vec{p}₁, . . . , \vec{p}_{R}), is a block vector including the respective space encoded vectors 65.p.1-R of the data item 25 for each of the space partitioning functions 210.1-R.

FIG. 3B is a schematic diagram depicting an example of a space partitioning function 210.r of the multi-to-single vector encoder 200.

In general, the space partitioning function 210.r is configured to: receive an embedding vector 35 belonging to the embedding vector space 130; and process the embedding vector 35 to assign the embedding vector 35 to one of the respective partitions 135.r.1-B of the embedding vector space 130 associated with the space partitioning function 210.r. In other words, the space partitioning function 210.r is configured to perform φᵣ(x)=b, for each x∈ [symbol] ^{d} with b∈[B]ᵣ.

Several types of partitioning functions can be utilized as the space partitioning function 210.r to perform this above operation. For example, the space partitioning function 210.r can implement random partitioning on the embedding vector space 130, a k-means partitioning on the embedding vector space 130, or hash-based partitioning on the embedding vector space 130. As one example of hash-based partitioning, the space partitioning function 210.r can be configured as a locality-sensitive hash (“LSH”) function that implements locality-sensitive hash partitioning on the embedding vector space 130. A desirable property of the locality-sensitive hash function is that embedding vectors 35 are more likely to collide the closer they are in the embedding vector space 130, that is, φᵣ(q)=φᵣ(p)=b. Moreover, when the embedding vectors 35 are normalized, e.g., such as those produced by ColBERT-style models, SimHash can be an effective choice for the locality-sensitive hash partitioning. Particularly, for any kₛᵢₘ≥1, the multi-to-single vector encoder 200 can initialize the space partitioning function 210.r by randomly sampling Gaussian vectors g₁, . . . , gₖ_{ₛᵢₘ}∈ [symbol] ^{d} from the embedding vector space 130, and setting the space partitioning function 210.r to φᵣ(x)=(1 [symbol] g₁,x [symbol] >0), . . . , 1( [symbol] gₖ_{ₛᵢₘ},x [symbol] 0)), where 1(⋅)∈{0, 1} is the indicator function. Converting the bit-string to decimal, φᵣ(x) gives a mapping from [symbol] ^{d} to [B]ᵣ where B=2^{k}^{ₛᵢₘ}. In other words, the space partitioning function 210.r partitions the embedding vector space ( [symbol] ^{d}) 130 by drawing kₛᵢₘ random half-spaces, and each of the 2^{k}^{ₛᵢₘ} partitions 135.r.1-B is formed by the kₛᵢₘ-wise intersection of each of the half-spaces or their complement. As another approach, the multi-to-single vector encoder 200 can choose k_{CENTER}≥1 centers from the collection of all the embedding vectors 45.p of the data items 25.1-n, that is

$${⋃}_{i = 1}^{n} {P}_{i} ,$$

either randomly or via k-means, and set φᵣ(x)∈[k_{CENTER}] to be the index of the center nearest to x. Note, this method was compared to SimHash in the experiments.

To generate the space encoded vector 65.q.r. of the query 15 for the space partition function 210.r, the multi-to-single vector encoder 200 is configured to perform the following operations:

The multi-to-single vector encoder 200 is configured to process each embedding vector 35.q in the set 32.Q of embedding vectors 35.q.1-Q of the query 15, using the space partitioning function 210.r, to assign the embedding vector 35.q to one of the respective partitions 135.r.1-B of the embedding vector space 130 associated with the space partitioning function 210.r.

Then, for each partition 135.r.b of the embedding vector space 130 associated with the space partitioning function 210.r, the multi-to-single vector encoder 200 is configured to sum each of the embedding vectors 35.q of the query 15 assigned to the partition 135.r.b to generate a respective partition encoded vector 60.q.r.b of the query 15 for the partition 135.r.b. The partition encoded vector 60.q.r.b of the query 15 is given as:

$${\vec{q}}_{r ( b )} = {{\sum }_{q ∈ Q}}_{{φ}_{r} ( q ) = b} q , \qquad ( 5 )$$

where \vec{q}_{r(b)}∈ [symbol] ^{d}.

The multi-to-single vector encoder 200 is configured to concatenate the respective partition encoded vectors 60.q.r.1-B of the query 15 for each of the respective partitions 135.r.1-B associated with the space partitioning function 210.r to generate the respective space encoded vector 65.q.r. of the query 15 for the space partition function 210.r. Thus, the space encoded vector 65.q.r of the query 15, given as \vec{q}ᵣ=(\vec{q}ᵣ₍₁₎, . . . , \vec{q}_{r(B)}), is a block vector including each of the partition encoded vectors 60.q.r.1-B of the data item 25.

In some implementations, the multi-to-single vector encoder 200 is further configured to apply a random projection matrix (S) 212.r to each partition encoded vector 60.q.r.b of the query 15 to generate a respective projected partition vector 60*q.r.b of the query 15. The random projection matrix 212.r, given as S∈ [symbol] ^{d}^{ₚᵣₒⱼ}^{×d} with dₚᵣₒⱼ<d, defines a random linear projection from the embedding vector space ( [symbol] ^{d}) 130 to an auxiliary vector space ( [symbol] ^{d}^{ₚᵣₒⱼ}) having lower dimensionality than the embedding vector space 130. For example, the random projection matrix 212.r can be a random matrix including uniformly distributed entries of ±1. The projected partition vector 60*q.r.b, given as \vec{q}_{r(b),ψ}=S\vec{q}_{r(b)}/√\vec{dₚᵣₒⱼ}, is a matrix vector product between the random projection matrix 212.r and the partition encoded vector 60.q.r.b, and normalized by a square root of the dimension (dₚᵣₒⱼ) of the auxiliary vector space. Under the random projection matrix 212.r, the space encoded vector 65.q.r of the query 15 is then generated by the multi-to-single vector encoder 200 as a concatenation of the projected partition vectors 60*q.r.1-B of the query 15, that is \vec{q}ᵣ=(\vec{q}_{r(1),ψ}, . . . , \vec{q}_{r(B),ψ}), which results in a dimension of dₚᵣₒⱼB for the space encoded vector 65.q.r. Moreover, after the complete mapping, this corresponds to a final dimension for the target vector space 140 of d_{FDE}=RdₚᵣₒⱼB.

To generate the space encoded vector 65.p.r of a data item 25 for the space partition function 210.r, the multi-to-single vector encoder 200 is configured to perform the following operations:

The multi-to-single vector encoder 200 is configured to process each embedding vector 35.p in the set 32.P of embedding vectors 35.p.1-P of the data item 25, using the space partitioning function 210.r, to assign the embedding vector 35.q to one of the respective partitions 135.r.1-B of the embedding vector space 130 associated with the space partitioning function 210.r.

Then, for each partition 135.r.b of the embedding vector space 130 associated with the space partitioning function 210.r, the multi-to-single vector encoder 200 is configured to sum each of the embedding vectors 35.p of the data item 25 assigned to the partition 135.r.b to generate a respective partition encoded vector 60.p.r.b of the data item 25 for the partition 135.r.b. The partition encoded vector 60.p.r.b of the data item 25 is given as:

$${\vec{p}}_{r ( b )} = \frac{1}{\vert P ⋂ {φ}_{r}^{- 1} ( b ) \vert} {{\sum }_{p ∈ P}}_{{φ}_{r} ( p ) = b} p \qquad ( 6 )$$

where \vec{p}_{r(b)}∈ [symbol] ^{d}. Particularly, the multi-to-single vector encoder 200 sets the partition encoded vector 60.p.r.b of the data item 25 to be the centroid of the embedding vectors 45.p of the data item 25 p∈P satisfying φᵣ(p)=φᵣ(q)=b.

The multi-to-single vector encoder 200 is configured to concatenate the respective partition encoded vectors 60.p.r.1-B of the data item 25 for each of the respective partitions 135.r.1-B associated with the space partitioning function 210.r to generate the respective space encoded vector 65.p.r. of the data item 25 for the space partition function 210.r. Thus, the space encoded vector 65.p.r of the data item 25, given as \vec{p}ᵣ=(\vec{p}ᵣ₍₁₎, . . . , \vec{p}_{r(B)}), is a block vector including each of the partition encoded vectors 60.p.r.1-B of the data item 25.

In some implementations, the multi-to-single vector encoder 200 is further configured to apply the random projection matrix 212.r to each partition encoded vector 60.p.r.b of the data item 25 to generate a respective projected partition vector 60*p.r.b of the data item 25. The projected partition vector 60*p.r.b, given as \vec{p}_{r(b),ψ}=S\vec{p}_{r(b)}/√\vec{dₚᵣₒⱼ}, is a matrix vector product between the random projection matrix 212.r and the partition encoded vector 60.p.r.b, and normalized by the square root of the dimension (dₚᵣₒⱼ) of the auxiliary vector space. As above for the query 15, under the random projection matrix 212.r, the space encoded vector 65.p.r of the data item 25 is then generated by the multi-to-single vector encoder 200 as a concatenation of the projected partition vectors 60*p.r.1-B of the data item 25, that is, \vec{p}ᵣ=(\vec{p}_{r(1),ψ}, . . . , \vec{p}_{r(B),ε}).

In general, the space partitioning function 210.r partitions the embedding vector space 130 into the set of partitions 135.r.1-B such that embedding vectors 35 that are nearest one another are likely to belong to the same partition 135.r.b. After partitioning via or, the ideal scenario is that, for each embedding vector 35.q of the query 15 q∈Q, the embedding vector 45.p of the data item 25 p∈P that is closest to the embedding vector 45.q of the query 15 belongs to the same partition 135.r.b. In other words, φᵣ(q)=φᵣ(p)=b. If this were to occur, then:

$$CHAMFER ( Q , P ) = {\sum }_{b = 1}^{B} {{\sum }_{q ∈ Q}}_{{φ}_{r} ( q ) = b} {{max}_{p ∈ P}}_{{φ}_{r} ( p ) = b} 〈 q , p 〉 . \qquad ( 7 )$$

Assuming, the space partitioning function 210.r implements the optimal partitioning, Eq. (7) is realized as the inner product [symbol] \vec{q}ᵣ, \vec{p}ᵣ [symbol] between the space encoded vectors 65.q.r and 65.p.r of the query 15 and data item 25, which is given as:

$$〈 {\vec{q}}_{r} , {\vec{p}}_{r} 〉 = {\sum }_{b = 1}^{B} {{\sum }_{q ∈ Q}}_{{φ}_{r} ( q ) = b} \frac{1}{\vert P ⋂ {φ}_{r}^{- 1} ( b ) \vert} {{\sum }_{p ∈ P}}_{{φ}_{r} ( p ) = b} 〈 q , p 〉 . \qquad ( 8 )$$

Considering this, one source of error in the partitioning is when the nearest item embedding vector p∈P to a given query embedding vector q∈Q maps to a different partition namely φᵣ(p)≠φ(q)=b. This can be made less likely by decreasing B, at the cost of making it more likely for other p′∈P to also map to the same partition, moving the centroid farther from p. If B is increased too much, it is possible that no p∈Pcollides with φ(q). To avoid this trade-off, the multi-to-single vector encoder 200 can directly confirm that if no p∈P maps to a partition b, then instead of setting \vec{p}ᵣ=0, the multi-to-single vector encoder 200 sets \vec{p}ᵣ to the embedding vector p that is closest to partition b. As a result, increasing B results in a more accurate estimator, as it results in smaller partitions. Particularly, for any partition b with

$$P ⋂ {φ}_{r}^{- 1} ( b ) = ∅ ,$$

if fill_empty_clusters is enabled, the multi-to-single vector encoder 200 sets \vec{p}ᵣ=p where p∈P is the embedding vector for which φ(p) has the fewest number of disagreeing bits with b, with ties broken arbitrarily.

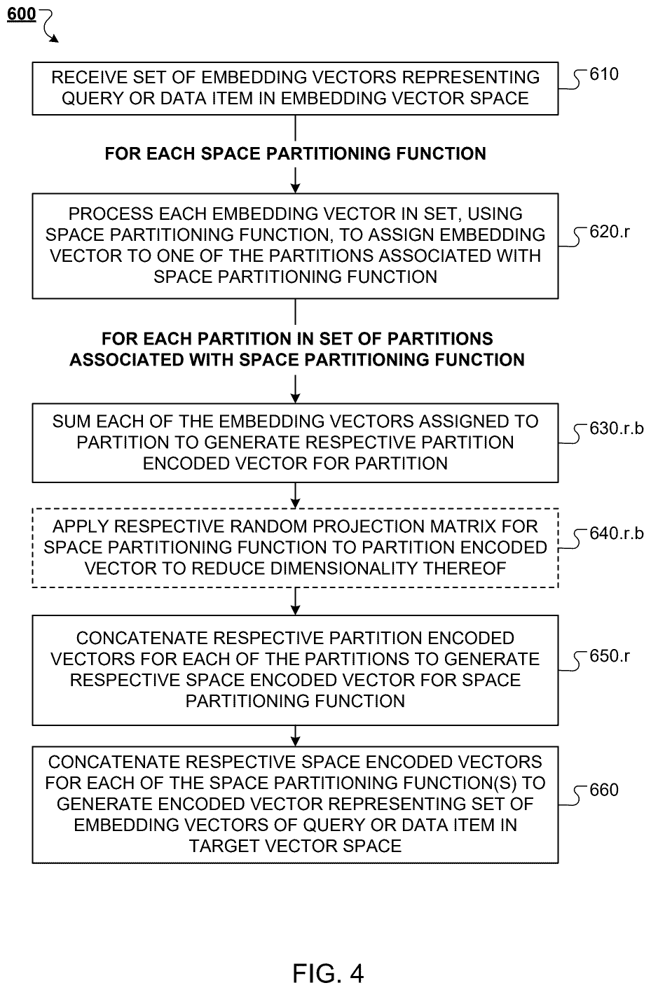

FIG. 4 is a flow diagram of an example process 600 for encoding a set 32.V of embedding vectors 35.1-V representing a query 15 or data item 25 in an embedding space 130 into an encoded vector 45 representing the set 32.V of embedding vectors 35.1-V of the query 15 or data item 25 in a target vector space 140. For convenience, the process 600 will be described as being performed by a system of one or more computers located in one or more locations. For example, a multi-to-single vector encoder, e.g., the multi-to-single vector encoder 200 of FIGS. 3A-3B, appropriately programmed in accordance with this specification, can perform the process 600.

The multi-to-single vector encoder 200 receives the set 32. V of embedding vectors 35.1-V representing the query 15 or data item 25 in the embedding vector space 130 (610).

For each of one or more space partitioning functions 210.1-R that are each associated with a respective set of partitions 135.r.1-B of the embedding vector space 130:

The multi-to-single vector encoder 200 processes each embedding vector 35.v in the set 32.V of embedding vectors 35.1-V of the query 15 or data item 25, using the space partitioning function 210.r, to assign the embedding vector 35.v to one of the respective partitions 135.r.1-B of the embedding vector space 130 associated with the space partitioning function 210.r (620.r).

For each partition 135.r.b in the respective set of partitions 135.r.1-B of the embedding vector space 130 associated with the space partitioning function 210.r:

The multi-to-single vector encoder 200 sums each of the embedding vectors 35 in the set 32. V of embedding vectors 35.1-V of the query 15 or data item 25 assigned to the partition 135.r.b to generate a respective partition encoded vector 60.r.b of the query 15 or data item 25 for the partition 135.r.b (630.r.b).

Optionally, the multi-to-single vector encoder 200 applies a respective random projection matrix 212.r for the space partitioning function 210.r to the respective partition encoded vector 60.r.b of the query 15 or data item 25 for the partition 135.r.b (640.r.b).

The multi-to-single vector encoder 200 concatenates the respective partition encoded vectors 60.r.1-B of the query 15 or data item 25 for each of the respective partitions 135.r.1-B of the embedding vector space 130 associated with the space partitioning function 210.r to generate a respective space encoded vector 65.r of the query 15 or data item 25 for the space partitioning function 210.r (650.r).

The multi-to-single vector encoder 200 concatenates the respective space encoded vectors 65.1-B of the query 15 or data item 25 for each of the one or more space partitioning functions 210.1-R to generate the encoded vector 45 representing the set 32.V of embedding vectors 35.1-V of the query 15 or data item 25 in the target vector space 140 (660).

### Experiments

The FDEs were evaluated as a method for multi-vector retrieval in several experiments, including offline, online, and end-to-end implementation experiments. The FDEs themselves were first evaluated offline as a proxy for Chamfer similarity. A discussion on the implementation of MUVERA in the online experiments is provided below, as well as several optimizations made in the search. Then, the latency of MUVERA was evaluated and compared to PLAID, with a study on the effects of the aforementioned optimizations.

The experiments included evaluation six BEIR information retrieval datasets: MS MARCO (CC BY-SA 4.0), HotpotQA (CC BY-SA 4.0), Quora (Apache-2.0), NQ (Apache-2.0), SciDocs (CC BY 4.0), and ArguAna (Apache-2.0). These datasets were selected for varying corpus size (8K-8.8M) and average number of document tokens. The development set was used for the experiments on MS MARCO, and the test set was used on the other datasets.

The FDEs were computed on multi-vector embeddings produced by the ColBERTv2 model (MIT License), which have a dimension of d=128 and a fixed number |Q|=32 of embeddings per query. The number of document embeddings was variable, ranging from an average of 18.3 on Quora to 165 on Scidocs. This resulted in 2,300-21,000 floats per document on average (e.g., 10,087 for MS MARCO). Thus, when constructing the FDEs we consider a comparable range of dimensions d_{FDE} between 1,000-20,000. Furthermore, using product quantization, it was shown that the FDEs can be significantly compressed by thirty-two times with minimal quality loss, further increasing the practicality of FDEs.

### Offline Evaluation of FDE Quality.

The quality of the FDEs was evaluated as a proxy for the Chamfer similarity, without any re-ranking and using exact offline search. It was first demonstrated that FDE recall quality improves dependably as the dimension d_{FDE} increases, making the method relatively easy to tune. It was then shown that FDEs are a more effective method of retrieval than the single-value heuristic. Specifically, the FDE method achieved Recall@N exceeding the Recall@2-4N of the single-value heuristic, while scanning a similar number of floats in the search. This suggests that the success of the single-value heuristic is largely due to the significant effort put towards optimizing it, and similar effort for FDEs may result in even higher efficiency gains. Note, all recall curves used a single FDE instantiation, since the variance of FDE recall was negligible. For example, the standard deviation Recall@1000 was at most 0.08-0.16% for FDEs with 2-10,000 dimensions.

FIGS. 5A-5C are experimental plots showing FDE recall versus dimension for varying FDE parameters on the MS MARCO dataset. FIG. 5A shows FDE Recall@100, FIG. 5B shown FDE Recall@1k, and FIG. 5C shows FDE Recall@10k left to right. Recalls@N for exact Chamfer scoring is shown by dotted lines.

The retrieval quality of FDE was shown to improve as a function of the dimension d_{FDE}. A grid search was performed over FDE parameters R∈{1, 5, 10, 15, 20}, kₛᵢₘ∈{2, 3, 4, 5, 6}, dₚᵣₒⱼ∈{8, 16, 32, 64}, and compute recall on MS MARCO (see FIGS. 5A-5C). It was found that Pareto optimal parameters were generally achieved by larger Rᵣₑₚₛ, with kₛᵢₘ and dₚᵣₒⱼ playing a lesser role in improving quality.

Specifically, (R, kₛᵢₘ, dₚᵣₒⱼ)∈{(20, 3,8), (20, 4, 8) (20, 5, 8), (20, 5, 16)} were all Pareto optimal for their respective dimensions, namely R·2^{k}^{ₛᵢₘ}·dₚᵣₒⱼ. While there were small variations depending on the parameter choice, the FDE quality was tightly linked to dimensionality; increase in dimensionality generally resulted in quality gains. Using k-means as a method of partitioning instead of SimHash was also evaluated. Here, the document embeddings were clustered with k-means and the partitioning function φ(x) was set to be the index of the nearest centroid to x. A grid search was performed over the same parameters, but with k∈{4, 8, 16, 32, 64} to match B=2^{k}^{ₛᵢₘ}. It was found that k-means partitioning offered similar quality on the Pareto Frontier as SimHash. Thus, for convenience, SimHash was chosen for partitioning for the remainder of the experiments.

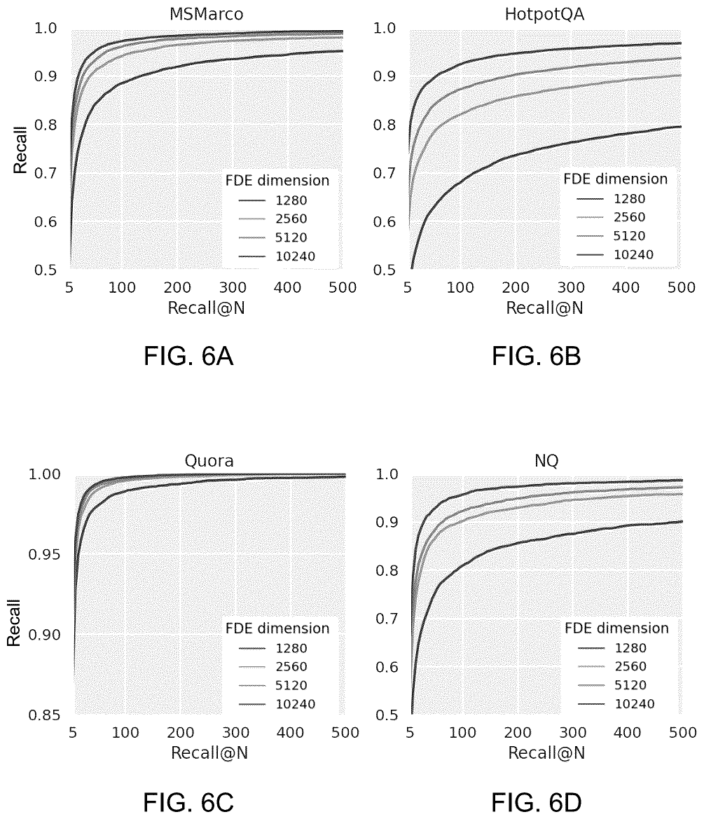

FIGS. 6A-6D are experimental plots showing comparisons of FDE recall versus brute-force search over Chamfer similarity. The FDE retrieval quality was evaluated with respect to the Chamfer similarity, instead of labelled ground truth data. FIG. 6A shows the evaluation on MS MARCO, FIG. 6B shows the evaluation on HotpotQA, FIG. 6C shows the Chamfer similarity evaluation on Quora, and FIG. 6D shows the evaluation on NQ.

For this experiment, the 1Recall@N was computed as the metric of evaluation, which is the fraction of queries for which the Chamfer 1-nearest neighbor is among the top-N most similar in the FDE inner product. The FDE parameters were Pareto optimal for the dimension, which were chosen from the abovementioned grid search. It was found that FDE's with fewer dimensions than the original multi-vector representations achieved respectable recall across multiple BEIR retrieval datasets. For instance, on MS MARCO, where d·m_{avg}≈10K, the FDEs achieved 95% recall while retrieving seventy-five or fewer candidates using d_{FDE}=5120.

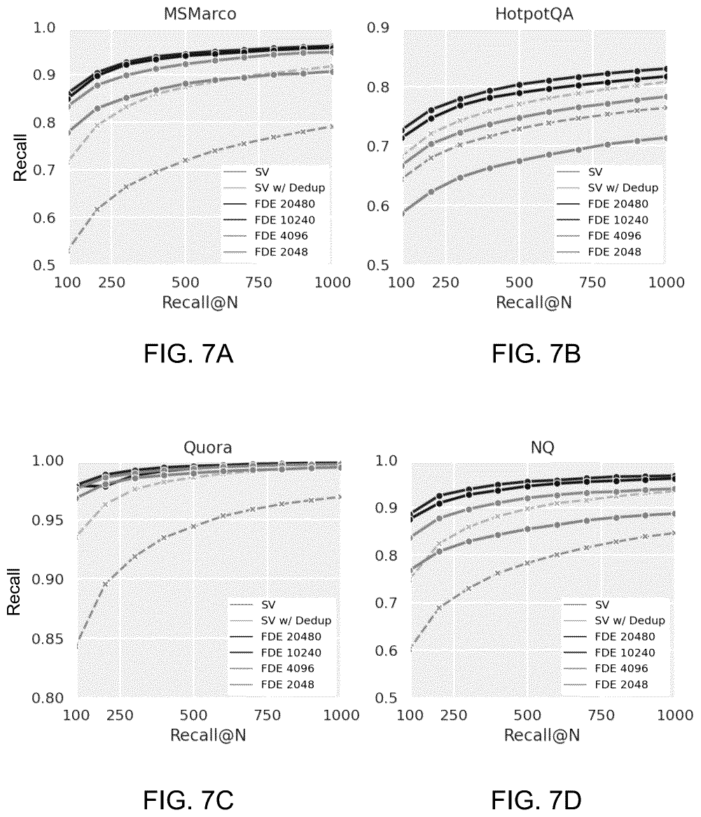

FIGS. 7A-7D are experimental plots showing FDE retrieval versus the single-value heuristic (e.g., PLAID), both with and without document ID deduplication. The quality of FDEs as a proxy for retrieval was compared against the single-value heuristic, which is the method underpinning PLAID. FIG. 6A shows the on MS MARCO, FIG. 6B shows the on HotpotQA, FIG. 6C shows the evaluation on Quora, and FIG. 6D shows evaluation on NQ.

To wit, in the single-value heuristic, for each of the i=1, . . . , 32 query vectors qᵢ, the k-nearest neighbors p_{1,i}, . . . , p_{k,i} are computed from the set ∪ᵢPᵢ of all documents token embeddings. To compute Recall@N, an ordered list was created [symbol] _{1,1}, . . . , [symbol] _{1,32}, [symbol] _{2,1}, . . . , where [symbol] _{i,j} is the document ID containing p_{i,j}, including the 1-nearest neighbors of the queries, then the 2-nearest neighbors, and so on. When re-ranking, duplicate document IDs can first be removed from this list. However, since duplicates could not be detected while performing the initial thirty-two single-value MIPS queries, the single-value heuristic over-retrieved to reach a desired number of unique candidates. Thus, the “true” recall curve of implementations of the single-value heuristic (e.g., PLAID) may be somewhere between the case of no deduplication and full deduplication. Both are presented in FIGS. 7A-7D.

To compare the cost of the single-value heuristic to running MIPS over the FDEs, the experiment evaluated the total number of floats scanned by both using a brute force search. The FDE method scanned n·d_{FDE} floats to compute the k-nearest neighbors. For the single-value heuristic, 32 brute force scans were run over n·m_{avg} vectors in 128 dimensions, where m_{avg} is the average number embeddings per document. For MS MARCO, where m_{avg}=78.8, the single-value heuristic searched through 32·128·78.8·n floats. This allowed for an FDE dimension of d_{FDE}=322,764 to have comparable cost. This comparison can also be extended to fast approximate search. For example, suppose that approximate MIPS over n vectors can be accomplished in sublinear ne time, for some ε∈(0, 1). Then, even the case of ε=0 still affords an FDE dimension of d_{FDE}=32·128=4,096.

FDEs were built once for each dimension, using R=40, kₛᵢₘ=6, dₚᵣₒⱼ=d=128, and then applying a final projection to reduce to the target dimension. On MS MARCO, the 4096-dimensional FDEs matched the recall of the deduplicated single-value heuristic while retrieving 1.75-3.75 times fewer candidates. That is, the Recall@N of the FDEs matched the Recall@1.75-3.75N of the single-value heuristic), and 10.5-15 times fewer candidates than the non-deduplicated single-value heuristic. For the 10240-dimension FDEs, these numbers were 2.6-5 and 20-22.5 times fewer, respectively. For example, 80% recall was achieved with 60 candidates when d_{FDE}=10,240 and with 80 candidates when d_{FDE}=4,096. In contrast, the single-value heuristic required 300 candidates for deduplication and 1,200 candidates for non-deduplication to achieve the same recall.

### Online Implementation and End-to-End Evaluation.

An example implementation of the multi-vector retrieval system 10, referred to as “MUVERA”, was implemented in C++ programming language. MUVERA is an FDE generation and end-to-end retrieval engine. FDE generation and various optimizations and their tradeoffs were discussed above. Here, implementation details of MUVERA for performing retrieval over the FDEs is provided, as well as additional optimizations.

The single-vector retrieval engine of MUVERA used a scalable implementation of DiskANN (MIT License), a state-of-the-art graph-based approximate nearest neighbor search (“ANNS”) algorithm. DiskANN indices were built using uncompressed document FDEs with a maximum degree of 200 and a build beamwidth of 600. The retrieval operated by querying the DiskANN index using beam search with beamwidth W, and subsequently re-ranking the retrieved candidates with Chamfer similarity. The tuning knob for MUVERA is W; increasing W increases the number of candidates retrieved by MUVERA, which generally improved the recall.

To improve re-ranking speed of MUVERA, the number of query embeddings was reduced by clustering them via a ball carving method and replacing the embeddings in each cluster with their sum. This sped up re-ranking without decreasing recall.

To further improve the memory usage of MUVERA, a vector compression technique called “product quantization” (or “PQ”) was implemented with asymmetric querying on the FDEs. Here, product quantization with C centers per group of G dimensions is referred to as “PQ-C-G”. For example, PQ-256-8 was found to provide the best tradeoff between quality and compression in the online experiments, which compresses every consecutive set of 8 dimensions to one of 256 centers. Thus, PQ-256-8 provides 32 times compression over storing each dimension using a single float, since each block of 8 floats is represented by a single byte.

The online experiments on MUVERA were implemented on a Google Compute Engine Machine Type c3-standard-176, which uses an Intel® Sapphire Rapids as its central processing unit (“CPU”) platform. The machine supports up to 176 hyper-threads. Latency experiments were run using a single thread. QPS experiments were run using all 176 threads.

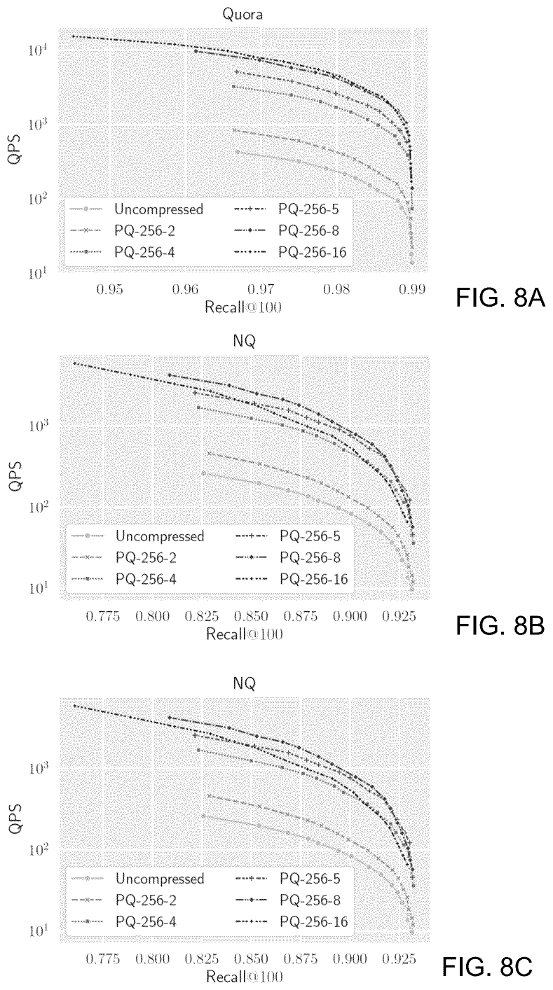

FIGS. 8A-8C are experimental plots showing queries per second (“QPS”) versus Recall@100 for MUVERA on a subset of the BEIR datasets. FIG. 8A shows the QPS evaluation on Quora, FIG. 8B shows the QPS evaluation on NQ, and FIG. 8C shows the QPS evaluation on MS MARCO. The different curves in the plots were obtained by using different product quantization (“PQ”) methods on 10240-dimensional FDEs.

The QPS is a useful metric for information retrieval, corresponding to the number of queries per second a system can serve at a given recall. Evaluating the QPS of a system involves fully utilizing the system's resources (e.g., the system's bandwidth of multiple memory channels and caches), and deployments where machines serve many queries simultaneously. As shown in FIGS. 8A-8C, using PQ-256-8 not only reduced the space usage of the FDEs by 32 times, but also improved the QPS at the same query beamwidth by up to 20 times, while incurring a minimal loss in end-to-end recall.

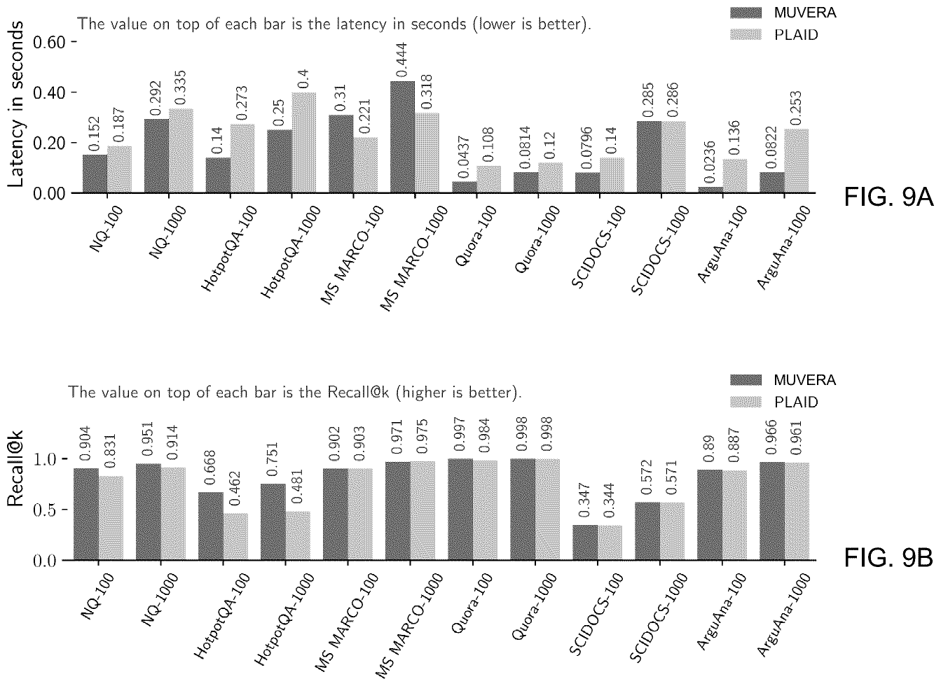

FIGS. 9A-9B are bar plots showing latency and Recall@k of MUVERA versus PLAID on a subset of the BEIR datasets. MUVERA and PLAID were evaluated on the six datasets from the BEIR benchmark described previous. FIG. 9A shows latency of MUVERA versus PLAID, and FIG. 9B shows Recall@k of MUVERA versus PLAID. MUVERA achieved roughly equivalent Recall@k as PLAID (within 0.4%) on MS MARCO, while obtaining up to 1.56 times higher recall on other datasets (e.g., HotpotQA). PLAID was run using the recommended settings. Compared with PLAID, on average over all six datasets and k∈{100, 1000}, MUVERA achieved 10% higher Recall@k (up to 56% higher), and 90% lower latency (up to 5.7 times lower).

Particularly, MUVERA had consistently high recall and low latency across all of the datasets that were measured, and no costly parameter tuning was involved to achieve this. All of the results used the same 10240-dimensional FDEs that were compressed using PQ with PQ-256-8. The only tuning in this system was to pick the first query beamwidth over the re-ranked top-k that obtained recall matching PLAID. As shown in FIGS. 9A-9B, in cases like NQ and HotpotQA, MUVERA obtained significantly higher recall at lower latency.

Thus, the online and end-to-end experiments on MUVERA demonstrate that the multi-vector retrieval system 10 can achieve consistently high recall and low latency across a wide variety of datasets with minimal tuning effort.

### SCOPE OF THE DISCLOSURE

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

### Other Embodiments

In addition to the embodiments of the attached claims and the embodiments described above, the following numbered embodiments are also innovative.
1. A method performed by one or more computers, the method comprising: obtaining a set of embedding vectors of a query in an embedding vector space; obtaining, for each of a plurality of data items, a respective encoded vector of the data item in a target vector space; encoding the set of embedding vectors of the query in the embedding vector space into an encoded vector of the query in the target vector space; performing, with respect to the encoded vector of the query, a k-nearest neighbors search on the respective encoded vectors of each of the plurality of data items; and identifying, from the k-nearest neighbors search, a top-k subset of the plurality of data items.
2. The method of embodiment 1, wherein obtaining the set of embedding vectors of the query in the embedding vector space comprises: receiving the query; and processing the query, using an encoder neural network, to generate the set of embedding vectors of the query in the embedding vector space.
3. The method of any one of embodiments 1-2, wherein the k-nearest neighbors search is an exact k-nearest neighbors search.
4. The method of any one of embodiments 1-2, wherein the k-nearest neighbors search is an approximate the k-nearest neighbors search.
5. The method of any one of embodiments 1-4, wherein the k-nearest neighbors search is a maximum inner product search.
6. The method of embodiment 5, wherein for each of the plurality of data items, a respective inner product between: (i) the encoded vector of the query, and (ii) the respective encoded vector of the data item, approximates a respective Chamfer similarity between: (i) the set of embedding vectors of the query, and (ii) a respective set of embedding vectors of the data item.
7. The method of any one of embodiments 1-6, further comprising: for each data item in the top-k subset: obtaining a respective set of embedding vectors of the data item in the embedding vector space; computing a respective Chamfer similarity between: (i) the set of embedding vectors of the query, and (ii) the respective set of embedding vectors of the data item; and determining a respective score for the data item based on the respective Chamfer similarity for the data item; ranking each data item in the top-k subset according to their respective scores; and selecting, from the top-k subset, the data item having the greatest respective score.
8. The method of embodiment 7, wherein for each data item in the top-k subset, obtaining the respective set of embedding vectors of the data item in the embedding vector space comprises: obtaining the data item; and processing the data item, using an encoder neural network, to generate the respective set of embedding vectors of the neural network in the embedding vector space.
9. The method of any one of embodiments 1-8, wherein encoding the set of embedding vectors of the query in the embedding vector space into the encoded vector of the query in the target vector space comprises: processing the set of embedding vectors of the query, using each of one or more space partitioning functions, to generate a respective space encoded vector of the query for the space partitioning function; and concatenating the respective space encoded vectors of the query for each of the one or more space partitioning functions to generate the encoded vector of the query.
10. The method of embodiment 9, wherein each of the one or more space partitioning functions implements random partitioning or k-means partitioning.
11. The method of embodiment 9, wherein each of the one or more space partitioning functions is a locality-sensitive hash function.
12. The method of embodiment 11, wherein each of the one or more locality-sensitive hash functions implements SimHash partitioning.
13. The method of any one of embodiments 9-12, wherein: the one or more space partitioning functions are each associated with a respective plurality of partitions of the embedding vector space, and each of the one or more space partitioning functions is configured to: receive an input embedding vector belonging to the embedding vector space; and process the input embedding vector to assign the input embedding vector to one of the respective plurality of partitions of the embedding vector space associated with the space partitioning function.
14. The method of embodiment 13, wherein processing the set of embedding vectors of the query, using each of the one or more space partitioning functions, to generate the respective space encoded vector of the query for the space partitioning function comprises, for each of the one or more space partitioning functions: processing each embedding vector in the set of embedding vectors of the query, using the space partitioning function, to assign the embedding vector to one of the respective plurality of partitions of the embedding vector space associated with the space partitioning function; for each of the respective plurality of partitions of the embedding vector space associated with the space partitioning function: summing each of the embedding vectors in the set of embedding vectors of the query assigned to the partition to generate a respective partition encoded vector of the query for the partition; and concatenating the respective partition encoded vectors of the query for each of the respective plurality of partitions of the embedding vector space associated with the space partitioning function to generate the respective space encoded vector of the query for the space partitioning function.
15. The method of embodiment 14, further comprising, for each of the one or more space partitioning functions: applying a respective random matrix for the space partitioning function to the respective partition encoded vectors of the query for each of the respective plurality of partitions of the embedding vector space associated with the space partitioning function.
16. The method of embodiment 15, wherein for each of the one or more space partitioning functions, the respective random matrix for the space partitioning function has uniformly distributed entries.
17. The method of any one of embodiments 15-16, wherein for each of the one or more space partitioning functions, the respective random matrix for the space partitioning function defines a random linear projection from the embedding vector space to another embedding vector space of lower dimensionality.
18. The method of any one of embodiments 1-17, wherein each of the query and plurality of data items comprises one or more of: a respective text sequence, a respective image, a respective video, a respective audio waveform, or a respective sensor dataset.
19. One or more non-transitory computer storage media storing instructions that, when executed by one or more computers, cause the one or more computers to perform operations of the respective method of any one of embodiments 1-18.
20. A system comprising: one or more computers; and one or more storage devices communicatively coupled to the one or more computers, wherein the one or more storage devices store instructions that, when executed by the one or more computers, cause the one or more computers to perform operations of the respective method of any one of embodiments 1-18.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a set of embedding vectors of a query in an embedding vector space;
obtaining, for each of a plurality of data items, a respective encoded vector of the data item in a target vector space;
encoding the set of embedding vectors of the query in the embedding vector space into an encoded vector of the query in the target vector space;
performing, with respect to the encoded vector of the query, a k-nearest neighbors search on the respective encoded vectors of each of the plurality of data items; and
identifying, from the k-nearest neighbors search, a top-k subset of the plurality of data items.

2. The method of claim 1, wherein obtaining the set of embedding vectors of the query in the embedding vector space comprises:
receiving the query; and
processing the query, using an encoder neural network, to generate the set of embedding vectors of the query in the embedding vector space.

3. The method of claim 1, wherein the k-nearest neighbors search is an exact k-nearest neighbors search.

4. The method of claim 1, wherein the k-nearest neighbors search is an approximate k-nearest neighbors search.

5. The method of claim 1, wherein the k-nearest neighbors search is a maximum inner product search.

6. The method of claim 5, wherein for each of the plurality of data items, a respective inner product between (i) the encoded vector of the query in the target vector space and (ii) the respective encoded vector of the data item in the target vector space approximates a respective Chamfer similarity between (i) the set of embedding vectors of the query in the embedding vector space and (ii) a respective set of embedding vectors of the data item in the embedding vector space.

7. The method of claim 1, further comprising:
for each data item in the top-k subset:
obtaining a respective set of embedding vectors of the data item in the embedding vector space;
computing a respective Chamfer similarity between: (i) the set of embedding vectors of the query, and (ii) the respective set of embedding vectors of the data item; and
determining a respective score for the data item based on the respective Chamfer similarity for the data item;
re-ranking the data items in the top-k subset according to their respective scores; and
selecting, from the re-ranked top-k subset, the data item having the greatest respective score based on the respective Chamfer similarity for the data item.

8. The method of claim 7, wherein for each data item in the top-k subset, obtaining the respective set of embedding vectors of the data item in the embedding vector space comprises:
obtaining the data item; and
processing the data item, using an encoder neural network, to generate the respective set of embedding vectors of the neural network in the embedding vector space.

9. The method of claim 1, wherein encoding the set of embedding vectors of the query in the embedding vector space into the encoded vector of the query in the target vector space comprises:
processing the set of embedding vectors of the query, using each of one or more space partitioning functions, to generate a respective space encoded vector of the query for the space partitioning function; and
concatenating the respective space encoded vectors of the query for each of the one or more space partitioning functions to generate the encoded vector of the query.

10. The method of claim 9, wherein each of the one or more space partitioning functions implements random partitioning or k-means partitioning.

11. The method of claim 9, wherein each of the one or more space partitioning functions is a locality-sensitive hash function.

12. The method of claim 11, wherein each of the one or more locality-sensitive hash functions implements SimHash partitioning.

13. The method of claim 9, wherein:
the one or more space partitioning functions are each associated with a respective plurality of partitions of the embedding vector space, and
each of the one or more space partitioning functions is configured to:
receive an input embedding vector belonging to the embedding vector space; and
process the input embedding vector to assign the input embedding vector to one of the respective plurality of partitions of the embedding vector space associated with the space partitioning function.

14. The method of claim 13, wherein processing the set of embedding vectors of the query, using each of the one or more space partitioning functions, to generate the respective space encoded vector of the query for the space partitioning function comprises, for each of the one or more space partitioning functions:
processing each embedding vector in the set of embedding vectors of the query, using the space partitioning function, to assign the embedding vector to one of the respective plurality of partitions of the embedding vector space associated with the space partitioning function;
for each of the respective plurality of partitions of the embedding vector space associated with the space partitioning function:
summing each of the embedding vectors in the set of embedding vectors of the query assigned to the partition to generate a respective partition encoded vector of the query for the partition; and
concatenating the respective partition encoded vectors of the query for each of the respective plurality of partitions of the embedding vector space associated with the space partitioning function to generate the respective space encoded vector of the query for the space partitioning function.

15. The method of claim 14, further comprising, for each of the one or more space partitioning functions:
applying a respective random matrix for the space partitioning function to the respective partition encoded vectors of the query for each of the respective plurality of partitions of the embedding vector space associated with the space partitioning function.

16. The method of claim 15, wherein for each of the one or more space partitioning functions, the respective random matrix for the space partitioning function has uniformly distributed entries.

17. The method of claim 15, wherein for each of the one or more space partitioning functions, the respective random matrix for the space partitioning function defines a random linear projection from the embedding vector space to another embedding vector space of lower dimensionality.

18. The method of claim 1, wherein each of the query and plurality of data items comprises one or more of: a respective text sequence, a respective image, a respective video, a respective audio waveform, or a respective sensor dataset.

19. One or more non-transitory computer storage media storing instructions that, when executed by one or more computers, cause the one or more computers to perform operations comprising:
obtaining a set of embedding vectors of a query in an embedding vector space;
obtaining, for each of a plurality of data items, a respective encoded vector of the data item in a target vector space;
encoding the set of embedding vectors of the query in the embedding vector space into an encoded vector of the query in the target vector space;
performing, with respect to the encoded vector of the query, a k-nearest neighbors search on the respective encoded vectors of each of the plurality of data items; and
identifying, from the k-nearest neighbors search, a top-k subset of the plurality of data items.

20. A system comprising:
one or more computers; and
one or more storage devices communicatively coupled to the one or more computers, wherein the one or more storage devices store instructions that, when executed by the one or more computers, cause the one or more computers to perform operations comprising:
obtaining a set of embedding vectors of a query in an embedding vector space;
obtaining, for each of a plurality of data items, a respective encoded vector of the data item in a target vector space;
encoding the set of embedding vectors of the query in the embedding vector space into an encoded vector of the query in the target vector space;
performing, with respect to the encoded vector of the query, a k-nearest neighbors search on the respective encoded vectors of each of the plurality of data items; and
identifying, from the k-nearest neighbors search, a top-k subset of the plurality of data items.
